(19) United States
(12) Patent Application Publication
(10) Pub. No.: US 2014/0192163 A1
(43) Pub. Date: Jul. 10, 2014

(54) IMAGE PICKUP APPARATUS AND INTEGRATED CIRCUIT THEREFOR, IMAGE PICKUP METHOD, IMAGE PICKUP PROGRAM, AND IMAGE PICKUP SYSTEM

(71) Applicant: Kenji Shimizu, Kanagawa (JP)

(72) Inventor: Kenji Shimizu, Kanagawa (JP)

(21) Appl. No.: 14/237,687

(22) PCT Filed: Aug. 21, 2012
(86) PCT No.: PCT/JP2012/005229

§ 371 Date: Feb. 7, 2014

(30) Foreign Application Priority Data
Oct. 11, 2011 (JP) 2011-223737

(51) Int. Cl. H04N 13/02

(52) U.S. Cl. CPC H04N 13/0207
USPC 348/46

(57) ABSTRACT

An imaging device generates distance information for each object in a plurality of images having the same viewpoint. During the generation, the imaging device detects distances from the viewpoint to some of the objects intermittently, and estimates the distances from the viewpoint to the other objects using the detected distances. The imaging device extracts object areas from the images, estimates the correspondence between the object areas of a target image targeted for distance estimation and the object areas of a reference image having been subjected to distance detection by a comparison therebetween, and allocates, for each of the object areas of the target image, the distance information of the corresponding object area of the reference image.

### TECHNICAL FIELD

The present invention relates to technology for generating a stereoscopic image, and in particular to technology for acquiring distance information for generating and processing a stereoscopic image.

### BACKGROUND ART

A common method for generating a stereoscopic image is to capture images from two different viewpoints. With this method, after or during the capturing of the images, it may be necessary to obtain another image by changing the position of one of the two viewpoints. For example, suppose that a mobile information terminal having a stereo camera is tilted 90° to photograph a subject. In this case, two viewpoint images aligned in a vertical direction are generated. In order to view the images stereoscopically without rotating the images, these images need to be converted into two viewpoint images aligned in a horizontal direction. In such a case, for each of the two viewpoint images, the distance between the viewpoint and each subject in the viewpoint image is calculated, and a stereoscopic image is generated under a desired condition, with use of the calculated distances and one of the two viewpoint images.

In order to acquire the distance between each subject and the viewpoint, disparity detection processing is necessary. The disparity detection processing refers to image matching processing in which pixels showing the same subject are searched for within two viewpoint images captured at the same time, and the pixels thus searched for are associated with each other. Specifically, for each pixel of a reference viewpoint image, which is one of the pair of viewpoint images, pixels that correspond to the pixel of the reference viewpoint image are searched for within the entirety of the other viewpoint image. Then, among the corresponding pixels thus searched for, a pixel having the highest similarity is regarded as a corresponding point.

However, such processing imposes a large processing load. In particular, in the case of moving images, high computation capability is required since the processing needs to be performed on at least 30 frames per second. As a result, an apparatus, such as a digital video camera, for simultaneously carrying out capturing of images for a stereoscopic image and display of the stereoscopic image, suffers from high power consumption. This leads to problems such as that operations with a rechargeable battery are difficult or that a rechargeable battery does not last long.

A known method for reducing the load of processing for generating distance information for moving images is to generate distance information for some frames, and to interpolate corresponding distance information for other frames (see Patent Literature 1, for example). Patent Literature 1 discloses a technology of acquiring moving image data (each frame being referred to as “frame image”) for generating stereoscopic images, and also intermittently acquiring distance image data for generating the stereoscopic images. Then, missing distance image data is generated for interpolation with use of the following method. First, a boundary area between a close view and a distant view is extracted from a distance image. Then, an outline area, which is either a corresponding boundary area or an area in the vicinity of the corresponding boundary area, is extracted from a frame image. Next, pattern matching is performed between the outline area of the frame image and a next frame image in a time axis, and the position of an area in the next frame image that corresponds to the outline area is calculated. Finally, the amount of movement of the outline area is calculated, and the distance image is moved by the amount of movement thus calculated, whereby a distance image corresponding to the next frame image is generated for interpolation.

### CITATION LIST

### Patent Literature

### [Patent Literature 1]

Japanese Patent No. 3988879

### SUMMARY OF INVENTION

### Technical Problem

However, according to the technology in Patent Literature 1, the boundary area between a distant view and a close view in the distance image generated for interpolation does not necessarily coincide with the outline of a photo-object in the frame image corresponding to the generated distance image for the following reason.

The outline of the photo-object in the frame image corresponding to the distance image does not necessarily coincide with the outline of the photo-object in the next frame image. However, according to the technology in Patent Literature 1, the distance image corresponding to the next frame image is generated for interpolation by moving the distance image corresponding to the frame image by the amount of movement that has been calculated. Accordingly, even if the outline of the photo-object in the next frame image changes from the outline of the photo-object in the frame image corresponding to the distance image, the boundary area between the distant view and the close view in the distance image generated for interpolation does not differ from the boundary area before the change. As a result, the outline of the photo-object in the next frame image may differ from the boundary area in the distance image corresponding to the next frame image.

The present invention has been achieved in view of the conventional problem described above, and an aim thereof is to provide imaging technology for estimating distance information without causing a mismatch in the outline of an object between an image and the distance information.

### Solution to Problem

The present invention provides an imaging device comprising: an image input unit configured to receive inputs of a first image and a second image that are captured at different times from the same viewpoint; an area division unit configured to divide each of the first image and the second image to extract areas corresponding one-to-one to objects; a distance detection unit configured to generate distance information for each area of the first image by detecting a distance from the viewpoint to the object corresponding to the area of the first image; a distance selection unit configured to select whether the distance detection unit is to generate distance information for each area of the second image by detecting a distance from the viewpoint to the object corresponding to the area of the second image; an area correspondence determination unit configured to, when the distance selection unit selects negatively, determine a correspondence between the areas of the first image and the areas of the second image; and a distance estimation unit configured to, based on a result of the determination by the area correspondence determination unit, generate distance information for the second image by associating each of the areas of the second image with the distance information, of one of the areas of the first image, that is estimated to indicate the distance from the viewpoint to the object corresponding to the area of the second image.

### Advantageous Effects of Invention

The imaging device according to the present invention estimates distance information without causing a mismatch in the outline of an object between an image and the distance information.

### BRIEF DESCRIPTION OF DRAWINGS

FIG. 1 is a block diagram showing an imaging device according to Embodiment 1.

FIG. 2 is a flowchart showing operations on a main image, which are performed by the imaging device according to Embodiment 1.

FIG. 3 is a schematic diagram showing image processing by the imaging device according to Embodiment 1.

FIG. 4 is a block diagram showing an imaging device according to Embodiment 2.

FIG. 5 is a flowchart showing operations on a main image, which are performed by the imaging device according to Embodiment 2.

FIG. 6 is a schematic diagram showing image processing by the imaging device according to Embodiment 2.

FIG. 7 is a block diagram showing an imaging device according to Embodiment 3.

FIG. 8 is a flowchart showing operations on a main image, which are performed by the imaging device according to Embodiment 3.

FIG. 9 is a schematic diagram showing image processing by the imaging device according to Embodiment 3.

FIG. 10 is a block diagram showing an imaging device according to Embodiment 4.

FIG. 11 is a block diagram showing an imaging device according to a modification of Embodiment 4.

FIG. 12 is a block diagram showing an integrated circuit according to Embodiment 1.

FIG. 13 is a block diagram showing an imaging system according to Embodiment 5.

FIG. 14 is a block diagram showing a conventional stereoscopic image generation device.

FIG. 15 shows a conventional method for controlling generation of a stereoscopic image.

FIG. 16 is a flowchart showing the conventional method for controlling generation of a stereoscopic image.

### DESCRIPTION OF EMBODIMENTS

(Background Leading to Invention)

A conventional method for capturing two images for stereoscopic viewing is to horizontally dispose two optical systems (each being composed of a lens and a sensor such as a CCD sensor) with a distance therebetween. This distance corresponds to an average distance between both eyes (approximately 6.5 cm). However, due to the recent appearance of twin-lens handheld digital video cameras, it is becoming increasingly popular for mobile information terminals, such as smartphones, to include a two-viewpoint stereo camera.

In devices such as handheld digital video cameras and mobile information terminals, horizontally disposing two optical systems with a distance of approximately 6.5 cm from each other will inhibit the size reduction of the devices. Also, since a handheld digital video camera or a mobile information terminal is often held by a hand of the operator, images are not always captured with the two viewpoints being aligned horizontally. For example, images may be captured with the mobile information terminal being rotated by 90°. In view of such a case, it is possible to employ a structure of generating a stereoscopic image after calculating the distance between a subject in a captured image and one of two viewpoints. In this way, the two viewpoints do not need to be aligned horizontally, and the distance between the two viewpoints does not need to be approximately 6.5 cm. Furthermore, this structure eliminates restrictions that inhibit the size reduction of a mobile information terminal, etc., thus allowing the operator of the mobile information terminal, etc., to capture images without worrying about the alignment of the two viewpoints.

However, this structure requires a large amount of computation for disparity detection, particularly in the case of moving images, as described above. Accordingly, the present inventors conducted a research on a method for reducing the load imposed by operations for detecting the distance between a subject and a viewpoint.

As a method for reducing the load imposed by operations for detecting the distance between a subject and a viewpoint, the distance detection may be performed intermittently, and interpolation may be performed for frames not subjected to the distance detection. However, as described above, the technology disclosed in Patent Literature 1 has a problem in which the outline of a photo-object in a frame image does not necessarily coincide with the outline of the photo-object in a distance image generated for interpolation.

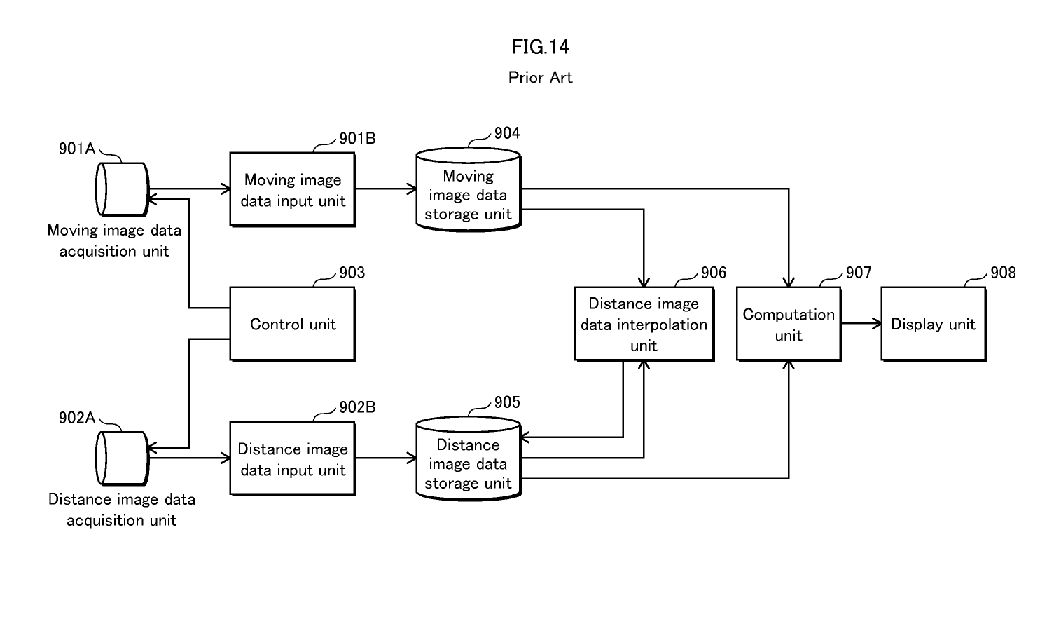

The following describes this problem with reference to the drawings. FIG. 14 is a block diagram showing a stereoscopic image generation device in Patent Literature 1.

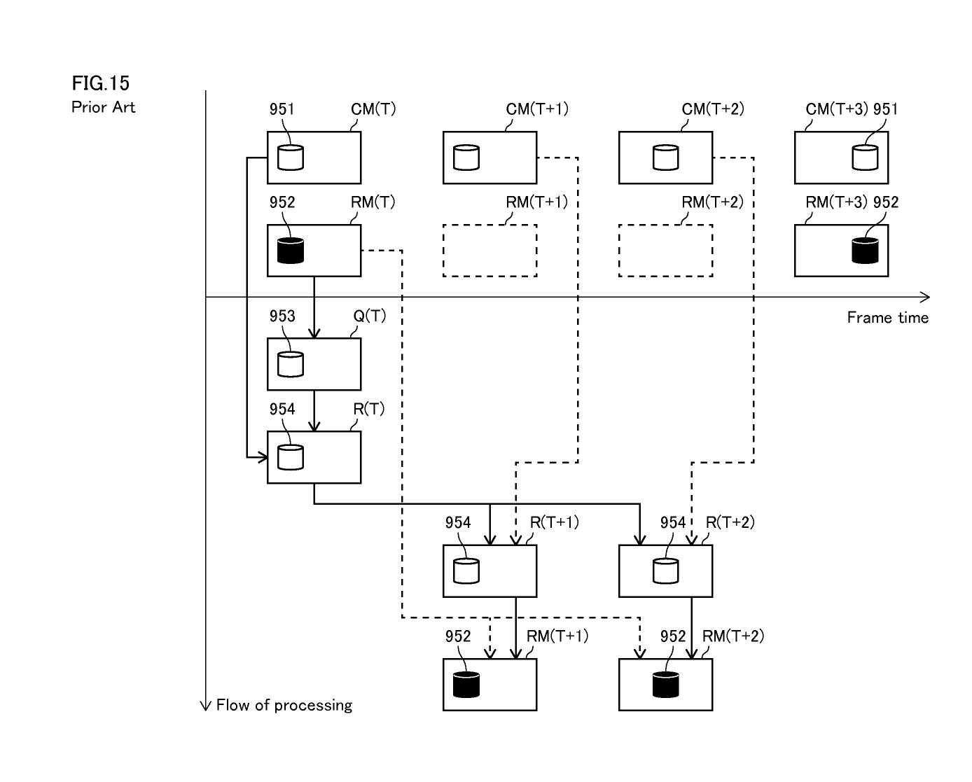

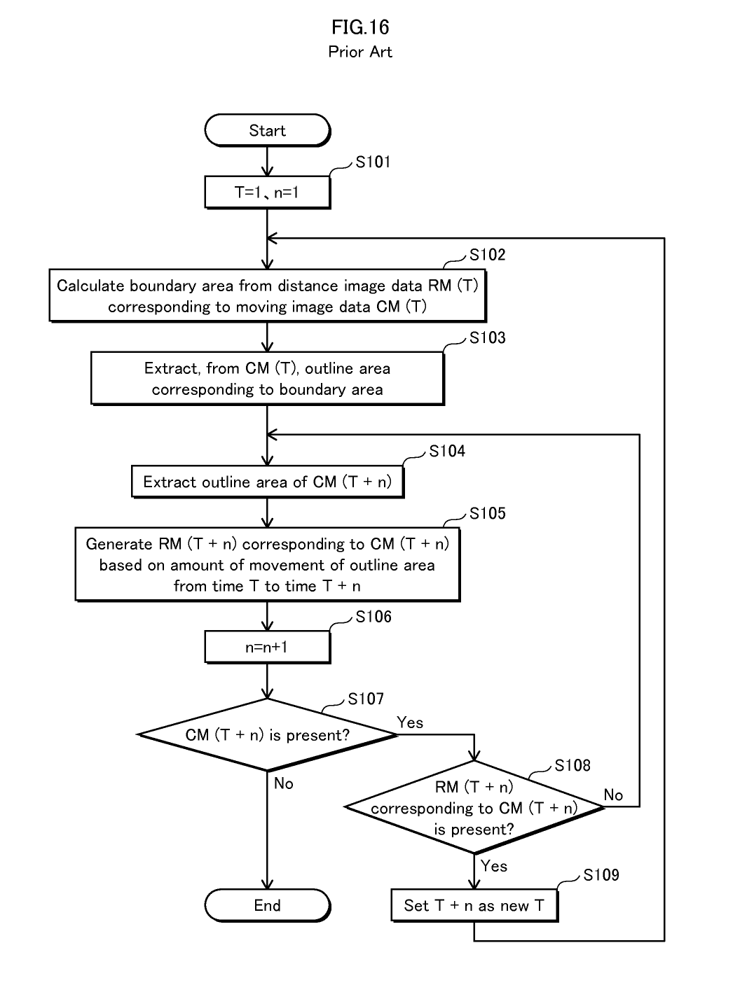

Operations of the stereoscopic image generation device in Patent Literature 1 are described below, with reference to the schematic diagram of FIG. 15 and the flowchart of FIG. 16. The stereoscopic image generation device inputs moving image data CM (T) and distance image data RM (T) as shown in FIG. 15, and stores the moving image data CM (T) and the distance image data RM (T) into a moving image data storage unit 904 and a distance image data storage unit 905, respectively. At this time, the moving image data CM (T) is input per frame, whereas the distance image data RM (T) is input intermittently, for example, once every three frames, as shown in FIG. 15. The distance image data RM (T) has 1-bit resolution. A black area 952 is a close-view area, and a white area is a distant-view area.

Next, a distance image data interpolation unit 906 of the stereoscopic image generation device generates pieces of distance image data RM (T+1) and RM (T+2) for interpolation, with use of pieces of moving image data CM (T), CM (T+1), and CM (T+2) and the distance image data RM (T). As shown in FIGS. 15 and 16, the distance image data interpolation unit 906 performs initialization (step S101), and calculates an image Q (T), which is an image of a boundary area 953 between the close view and the distant view (step S102). Next, the distance image data interpolation unit 906 calculates an image R (T) of an outline area 954, which is either an area that coincides with the boundary area 953 in the image Q (T) or an area that is in the vicinity of the area that coincides with the boundary area 953, from the moving image data CM (T) input at the same time as the distance image data RM (T) (step S103). Next, the distance image data interpolation unit 906 calculates an image R (T+1) showing an area that coincides with the outline area 954 of the image R (T) from the moving image data CM (T+1) at time T+1, with use of a pattern matching method (step S104). Next, the distance image data interpolation unit 906 moves the black area 952 (i.e., close-view area) in the distance image data RM (T) at time T, according to the amount of movement of the outline area 954 in the image R (T+1) calculated in step S104 with respect to the outline area 954 in the image R (T), and thereby generates distance image data RM (T+1) at time T+1 (step S105). Note that the distance image data interpolation unit 906 may calculate motion vectors indicating the motion between the moving image data with distance image data and next moving image data with no distance image data in a frame time axis, divide the distance image data into unit areas of the motion vectors, move the unit areas according to the motion vectors, and thereby generate distance image data for interpolation.

However, the outline of a subject 951 in the moving image data CM (T+1) does not necessarily coincide with the shape of the boundary area 953 between the close view and the distant view in the generated distance image data RM (T+1). This is because the outline of the subject 951 in the moving image data CM (T+1) does not necessarily coincide with the outline of the subject 951 in the moving image data CM (T). For example, suppose that the subject 951 approaches a moving image data acquisition unit 901 of the stereoscopic image generation device, resulting in the subject 951 in the moving image data CM (T+1) being larger than the subject 951 in the moving image data CM (T). Even in such a case, the size of the boundary area 953 between the close view and the distant view in the distance image data RM (T+1) that is generated for interpolation is the same as the size of the boundary area 953 in the distance image data RM (T), i.e., is the same as the subject 951 in the moving image data CM (T). This leads to a discrepancy in size between the outline of the subject 951 in the moving image data CM (T+1) and the shape of the boundary area 953 between the close view and the distant view in the distance image data RM (T+1).

Also, the stereoscopic image generation device according to Patent Literature 1 performs pattern matching in which an area corresponding to the outline area of the image R (T) is searched for within all areas of the moving image data CM (T+1), or calculates motion vectors to search for corresponding points between the moving image data CM (T+1) and the moving image data CM (T). Such processing imposes a large processing load and requires high processing capability. For example, during calculation of the motion vectors, pixels that correspond to a pixel in a reference image captured at a given time point are searched for within an image captured at a different time point and, among the corresponding pixels thus searched for, a pixel having the highest similarity is regarded as a corresponding point. This processing is similar to the disparity detection processing in which pixels that correspond to a pixel of a reference viewpoint image are searched for within another viewpoint image. Accordingly, even if the motion vector calculation processing is performed instead of the disparity detection processing, the amount of computation cannot be reduced greatly.

In view of the above, the present inventors have arrived at the idea of: dividing each of the frame images into areas in units of objects (or in smaller units) with use of a graph cut method or the like; determining the correspondence between areas by performing matching processing between an image with distance information and an image targeted for processing so as to search for areas of the target image corresponding to areas of the image with the distance information; and allocating each of the areas of the target image with the distance information of the corresponding area of the image having the distance information. In this way, the distance information of each area of the image is associated with the corresponding area of the target image, and the outline of an object in the target image thus coincides with the outline of the object in the corresponding distance information. Also, during the matching processing for each area, it is not necessary to search the entirety of the image with the distance information for a corresponding area that corresponds to an area of the target image, since the image with the distance information is also divided into areas. This makes it possible to reduce the amount of computation during the matching processing.

### EMBODIMENTS

The following describes embodiments of the present invention with reference to the drawings.

### Embodiment 1

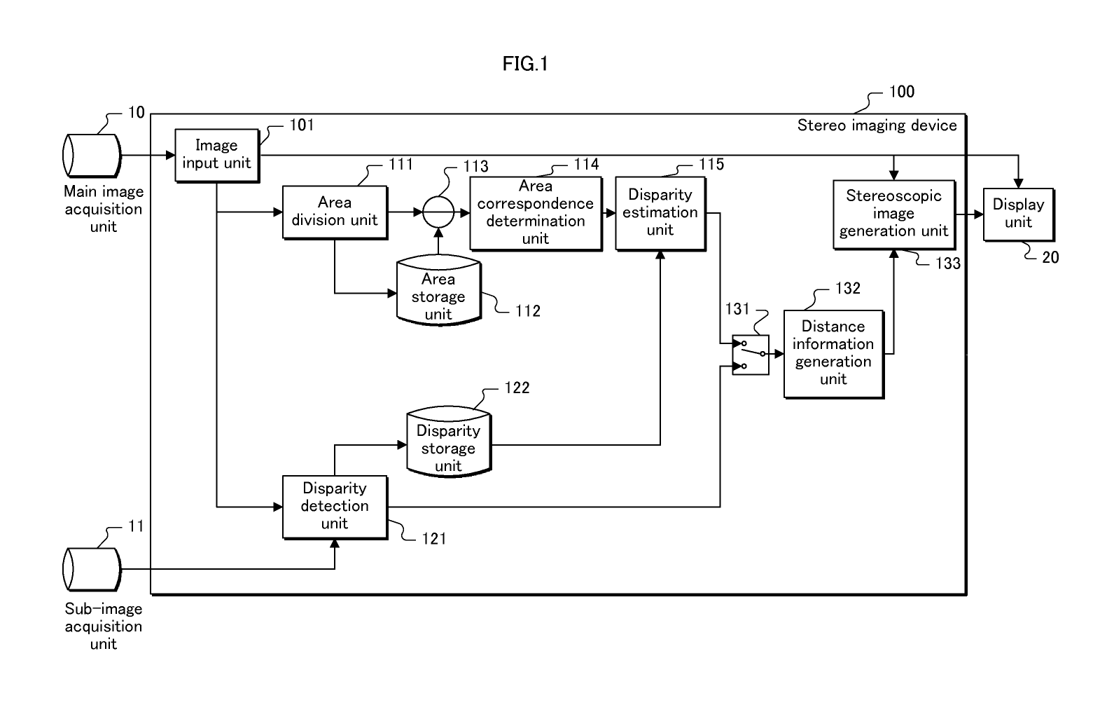

FIG. 1 is a block diagram showing an imaging device according to Embodiment 1 of the present invention.

Concerning FIG. 1, a stereo imaging device 100 captures images of a subject so as to be stereoscopically viewable, generates distance data based on data on the captured images, adjusts disparity between the images or modifies the viewpoint of one of the images based on the distance data and the image data, and thereby displays a stereoscopic image. The stereo imaging device 100 is connected to a main image acquisition unit 10, a sub-image acquisition unit 11, and a display unit 20.

<Structure>

As shown in FIG. 1, the stereo imaging device 100 includes an image input unit 101, an area division unit 111, an area storage unit 112, an area comparison unit 113, an area correspondence determination unit 114, a disparity estimation unit 115, a disparity detection unit 121, a disparity storage unit 122, a disparity selection unit 131, a distance information generation unit 132, and a stereoscopic image generation unit 133.

The main image acquisition unit 10 and the sub-image acquisition unit 11 are disposed with a distance of 6.5 cm (average distance between both eyes of a human) therebetween, for example. Each of the main image acquisition unit 10 and the sub-image acquisition unit 11 captures an image of a subject, and outputs a video signal obtained by the capturing of the image. The video signals output from the main image acquisition unit 10 and the sub-image acquisition unit 11 are collectively referred to as a stereo video signal. Also, the image indicated by the video signal output from the main image acquisition unit 10 is referred to as a main image, and the image indicated by the video signal output from the sub-image acquisition unit 11 is referred to as a sub-image. The main image acquisition unit 10 and the sub-image acquisition unit 11 generate respective images at the same time (timing) and output the images. The combination of the main image and the sub-image generated at the same time allows for stereoscopic viewing and for calculation of the distance to each of the subjects in the main image and the sub-image. According to the present embodiment, it is assumed that the main image acquisition unit 10 and the sub-image acquisition unit 11 each output 30 images per second.

The image input unit 101 receives an input of the main image from the main image acquisition unit 10.

The area division unit 111 acquires the main image from the image input unit 101, and performs processing for dividing the main image into areas, such as object areas and a background area. More specifically, a graph cut algorithm is used to perform area extraction while each subject in the main image is regarded as one area (segment).

The area storage unit 112 is a recording medium for storing area data output from the area division unit 111, and is realized by a hard disk drive, a solid state disk (SSD), a semiconductor memory, or the like, for example. The area data refers to information for specifying each area generated by the area division unit 111, and is specifically composed of: information indicating the main image before division; and the coordinate values of all pixels within each of the areas of the main image. The information for specifying each of the areas is not limited to the coordinate value of each of the pixels constituting the area. For example, the information may be vectors indicating the outline of each area or the coordinate values of all pixels constituting the outline.

The disparity detection unit 121 acquires main images from the image input unit 101 and sub-images from the sub-image acquisition unit 11, and detects disparity between a main image and a sub-image generated at the same time (timing). The disparity detection unit 121 calculates corresponding positions between the main image and the sub-image, calculates the distance between the corresponding positions in units of pixels, detects the calculated distance as disparity, and outputs disparity data (d) indicating the detected disparity. More specifically, disparity detection is performed with use of a block matching method. To evaluate the similarity between images, areas that are each composed of 16×16 pixels are cut out from each of the main image and the sub-image, and the sum of absolute differences (SAD) in brightness between each of the cut-out areas of the main image and each of the cut-out areas of the sub-image is calculated. Based on a result of the calculation, a cut-out position at which the SAD is at minimum is searched for, whereby the corresponding positions are calculated in units of pixels.

The disparity storage unit 122 is a recording medium for storing a disparity value for each pixel output from the disparity detection unit 121, and is realized by a hard disk drive, an SSD, a semiconductor memory, or the like, for example.

The area comparison unit 113 makes a comparison in area attribute between the areas of a main image output from the area division unit 111 and the areas of another main image generated at a different time and stored in the area storage unit 112. Examples of the area attribute of an area include the shape of the area, position information indicating the centroid position of the area, the size of the area, the position of the area, etc. Specifically, subtraction processing is performed on the areas of the main image output from the area division unit 111 and the areas of the main image generated at the different time and stored in the area storage unit 112. Based on the subtraction processing, area comparison data, which is differential data for each area of the main image, is created.

With reference to the area comparison data output from the area comparison unit 113, the area correspondence determination unit 114 determines the correspondence between the areas of the main image output from the area division unit 111 and the areas of the main image generated at the different time and stored in the area storage unit 112, and generates area determination data indicating a result of the determination. Specifically, the area correspondence determination unit 114 generates the area determination data by estimating and determining the correspondence between the areas of the main images based on the size of an overlap area. The overlap area is an area in which an area of the main image output from the area division unit 111 overlaps an area of the main image at the different time stored in the area storage unit 112. This is because a combination of areas corresponding to the largest overlap area is estimated to be a combination of areas corresponding to the same subject, provided that the frame rate of the main images is sufficient (i.e., at least 30 fps). Note that the area determination data is a list showing combinations of areas, and each of the combinations consists of an area of the main image output from the area division unit 111 and a corresponding area of the main image at the different time stored in the area storage unit 112.

The disparity estimation unit 115 acquires the area determination data from the area correspondence determination unit 114 and, for each of the areas output from the area division unit 111, acquires, from the disparity storage unit 122, disparity data of an area that is of the main image generated at the different time and stored in the area storage unit 112, and that corresponds to the area output from the area division unit 111, and outputs the disparity data as disparity estimation data.

The disparity selection unit 131 selects whether the disparity detection unit 121 is to generate disparity data used by the distance information generation unit 132. When the selection is made such that the disparity detection unit 121 is to generate the disparity data, the disparity selection unit 131 outputs, to the distance information generation unit 132, the disparity data detected by the disparity detection unit 121. When the selection is made such that the disparity detection unit 121 is not to generate the disparity data, the disparity selection unit 131 outputs, to the distance information generation unit 132, disparity estimation data output by the disparity estimation unit 115. Specifically, the disparity selection unit 131 makes a selection such that the disparity detection unit 121 is to generate disparity data at intermittent timings (e.g., once every two frames), and that the disparity estimation unit 115 is to estimate disparity data at other timings. Note that the disparity detection unit 121 stops operations while not generating disparity data, and that the area correspondence determination unit 114 and the disparity estimation unit 115 stop operations while the disparity detection unit 121 generates disparity data.

According to the present embodiment, the intermittent timings are set to once every two frames, and detection of disparity by the disparity detection unit 121 and estimation of disparity by the disparity estimation unit 115 are alternately performed on a per-frame basis.

The distance information generation unit 132 associates each of the areas output from the area division unit 111 with the corresponding disparity data output from the disparity selection unit 131, and generates distance information which is information used in combination with the main image so as to generate a two-viewpoint stereoscopic image. Specifically, each of the areas output from the area division unit 111 is filled with an intermediate value (median) of disparity data corresponding to the area, and each pixel in the area is thereby associated with the disparity data. Subsequently, the disparity data of each pixel is converted into distance information indicating the distance between the viewpoint and the subject. The above processing is performed to avoid large variations in disparity values in each of the areas.

The stereoscopic image generation unit 133 performs 2D/3D conversion processing (DIBR: Depth-Image-Based-Rendering) using the distance information generated by the distance information generation unit 132 and the main image output from the image input unit 101, and either converts the main image into a sub-image having a different viewpoint from the sub-image output from the sub-image acquisition unit 11 or creates a sub-image on which disparity adjustment has been performed. This allows for generation of a stereoscopic image using binocular parallax even when the main image acquisition unit 10 and the sub-image acquisition unit 11 are not aligned horizontally, for example, are aligned obliquely or vertically.

The display unit 20 acquires the main image and the sub-image from the image input unit 101 and the stereoscopic image generation unit 133 respectively, and displays these images in a manner that allows for stereoscopic viewing. The display unit 20 is realized by a liquid crystal display and a parallax barrier, for example.

<Operations>

The following describes operations of the stereo imaging device 100 according to the present embodiment, with reference to the drawings.

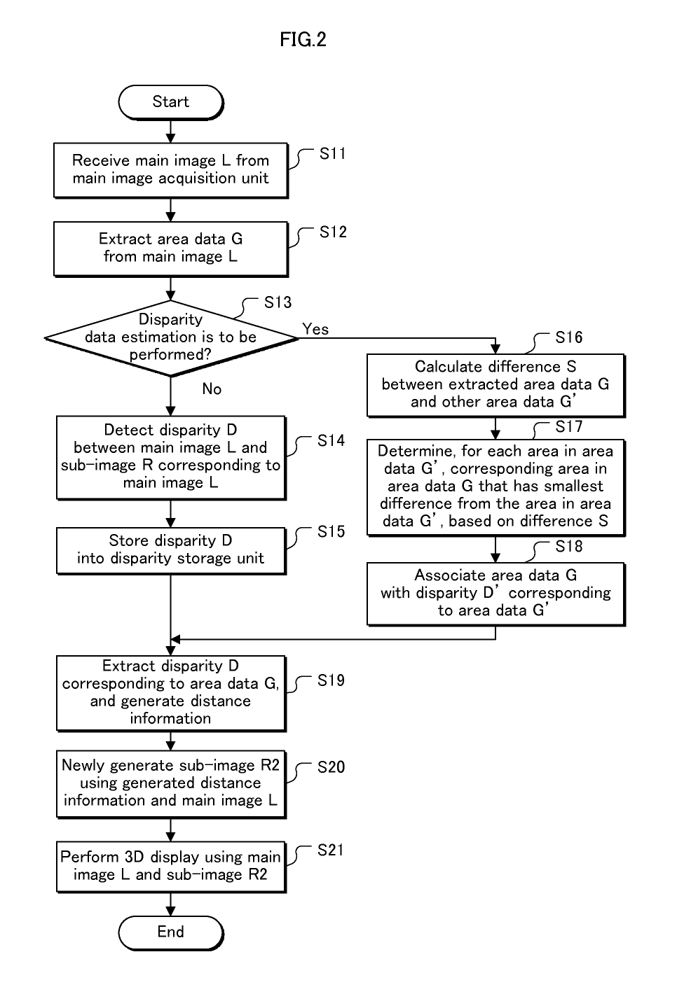

FIG. 2 is a flowchart showing operations on a main image, which are performed by the stereo imaging device 100 according to the present embodiment.

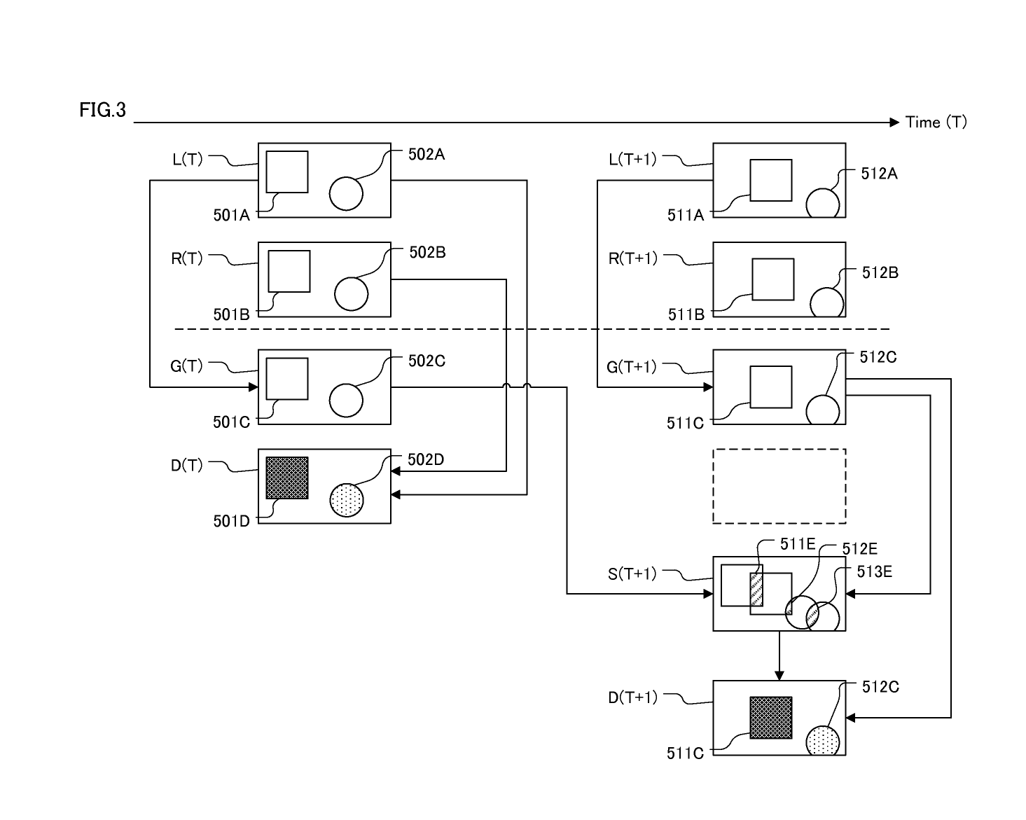

FIG. 3 is a schematic diagram showing a main image, a sub-image, and distance information according to the present embodiment.

First, the stereo imaging device 100 sets parameters for viewpoint conversion, disparity adjustment, etc. The parameters are, for example, a focal distance, a distance between viewpoints after conversion, etc.

The following describes operations of the stereo imaging device 100 on each frame of moving images. As described above, in the stereo imaging device 100, disparity detection by the disparity detection unit 121 and disparity estimation by the disparity estimation unit 115 are alternately performed on a per-frame basis. Specifically, at time T, the disparity detection unit 121 detects disparity between a main image L (T) and a sub-image R (T) and generates disparity data D (T), and at time T+1, the disparity estimation unit 115 estimates disparity data D (T+1) based on a main image L (T+1), and the main image L (T) and the disparity data D (T) that each correspond to time T. In other words, the main image L (T) at time T is not only targeted for disparity detection but also serves as a “first image” used to estimate the disparity data D (T+1). Also, the main image L (T+1) at time T+1 serves as a “second image” used to estimate the disparity data D (T+1), together with the main image L (T), which is the first image, and the disparity data (source data for distance information) D (T) corresponding to the main image L (T).

The following describes operations of the stereo imaging device 100 at time T and time T+1. At time T+2 and time T+3, the stereo imaging device 100 repeats similar operations with use of a main image L (T+2) as the first image and the a main image L (T+3) as the second image. Therefore, details of the operations at times T+2 and T+3 are omitted.

First, descriptions are provided of operations of the stereo imaging device 100 at time T, i.e., operations on the first image.

In the operations of the stereo imaging device 100, the image input unit 101 acquires the main image L (T) from the main image acquisition unit 10, and the disparity detection unit 121 acquires the sub-image R (T) from the sub-image acquisition unit 11 (step S11).

Next, the area division unit 111 extracts photo-objects 501C and 502C from the main image L (T) with use of a graph cut algorithm, generates area data G (T), and stores the area data G (T) into the area storage unit 112 (step S12).

Next, the disparity selection unit 131 selects whether disparity data estimation is to be performed (step S13). Here, the disparity selection unit 131 makes a selection such that the disparity detection unit 121 is to detect disparity and generate disparity data (No in step S13).

Next, the disparity detection unit 121 searches for corresponding points between the main image L (T) and the sub-image R (T), associates a photo-object 501A with a photo-object 501B, and a photo-object 502A with a photo-object 502B, and thereby generates disparity data D (T) (step S14).

The disparity detection unit 121 stores the disparity data D (T) into the disparity storage unit 122 (step S15).

The disparity selection unit 131 outputs the disparity data D (T) to the distance information generation unit 132. Then, the distance information generation unit 132 extracts, from the disparity data D (T), disparities (501D and 502D) corresponding to pieces of area data (501C and 502C) in the area data G (T), and generates distance information (step S19).

Next, the stereoscopic image generation unit 133 newly generates a sub-image R2 (T) with use of: the distance information generated by the distance information generation unit 132; and the main image L (T), according to parameters for viewpoint conversion, disparity adjustment, etc (step S20).

The display unit 20 performs stereoscopic display with use of the main image L (T) and the sub-image R2 (T) (step S21).

Next, descriptions are provided of operations of the stereo imaging device 100 at time T+1, i.e., operations on the main image L (T+1) which serves as the second image when the main image L (T) is assumed to be the first image.

In the operations of the stereo imaging device 100, the image input unit 101 acquires the main image L (T+1) from the main image acquisition unit 10, and the disparity detection unit 121 acquires the sub-image R (T+1) from the sub-image acquisition unit 11 (step S11).

Next, the area division unit 111 extracts photo-objects 511C and 512C from the main image L (T+1) with use of a graph cut algorithm, generates area data G (T+1), and stores the area data G (T+1) into the area storage unit 112 (step S12).

Next, the disparity selection unit 131 selects whether disparity data estimation is to be performed (step S13). Here, the disparity selection unit 131 makes a selection such that the disparity estimation unit 115 is to estimate disparity data (Yes in step S13).

The area comparison unit 113 reads the area data G (T) for comparison from the area storage unit 112, and calculates, as area comparison data, a difference S (T+1) between the area data G (T+1) and the area data G (T) (step S16).

Next, the area correspondence determination unit 114 generates area determination data based on the area comparison data S (T+1) (step S17). Specifically, the area 501C is determined as a candidate for an area corresponding to the area 511C, based on an overlap area 511E, and the area 502C is determined as another candidate for the area corresponding to the area 511C, based on an overlap area 512E. Then, the size of the overlap area 511E is compared to the size of the overlap area 512E, and the area 501C, which corresponds to the overlap area 511E having a larger size, i.e., having a smaller difference with respect to the area 511C, is associated with the area 511C. Similarly, the area 502C is determined as the area corresponding to the area 512C, based on an overlap area 513E. Since only the area 502C can be determined as a candidate for an area corresponding to the area 512C, the area 502C is associated with the area 512C.

After the areas of the area data G (T+1) are associated with the areas of the area data G (T), the disparity estimation unit 115 associates the areas of the area data G (T+1) with disparities of the disparity data D (T) corresponding to the areas of the area data G (T), and thereby generates disparity data D (T+1) (step S18). Specifically, since the area 511C is associated with the area 501C, the disparity estimation unit 115 associates the disparity of the area 501D corresponding to the area 501C with the area 511C. Similarly, the disparity of the area 502D is associated with the area 512C.

The disparity selection unit 131 outputs the disparity data D (T+1) to the distance information generation unit 132, and the distance information generation unit 132 extracts, from the disparity data D (T+1), the disparities corresponding to the areas (511C and 512C) of the area data G (T+1), fills each of the areas with an intermediate value (median) of the disparities (511D or 512D) corresponding to the area to generate distance information (step S19).

Next, the stereoscopic image generation unit 133 newly generates a sub-image R2 (T+1) with use of: the distance information generated by the distance information generation unit 132; and the main image L (T+1), according to parameters for viewpoint conversion, disparity adjustment, etc (step S20).

The display unit 20 performs stereoscopic display with use of the main image L (T+1) and the sub-image R2 (T+1) (step S21).

<Supplementary Remarks>

(1) According to the present embodiment, when two or more areas in a main image are determined as candidates for an area corresponding to a given area in another main image, the corresponding area is determined based on the size of an overlap area. However, the corresponding area may be determined based on the similarity in shape between each of the two or more areas and the given area, and the corresponding area may be the area having the most similar shape to the given area as a result of comparison. Alternatively, the corresponding area may be determined based on the centroid position of each area, and the corresponding area may be the area whose centroid position is the closest to the centroid position of the given area.

Yet alternatively, the corresponding area may be determined based on a combination of the above methods. For example, when there is no overlap area, the area whose centroid position is the closest to the centroid position of the given area may be determined as the corresponding area. Also, when there is more than one overlap area with respect to the given area, the area having the most similar shape to the given area may be determined as the corresponding area. This makes it possible to determine the correspondence between areas even when there is no candidate for an area corresponding to a given area or when there is more than one candidate for an area corresponding to a given area.

(2) According to the present embodiment, intermittent timings are set to once every two frames, so that detection of disparity by the disparity detection unit 121 and estimation of disparity by the disparity estimation unit 115 are alternately performed on a per-frame basis. However, if, for example, the main image acquisition unit 10 and the sub-image acquisition unit 11 each output 24 images per second, the intermittent timings may be set to twice every three frames, so that the disparity detection unit 121 continuously performs disparity detection for two frames and thereafter the disparity estimation unit 115 performs disparity estimation for one frame, and this operation may be repeatedly performed.

(3) According to the present embodiment, estimation of disparity data at time T+1 is performed with use of the area data and the disparity data at time T immediately before time T+1. However, no limitation is intended thereby and the estimation may be performed with use of the area data and the disparity data at an arbitrary time. For example, the area data and the disparity data at time T−2 may be used to estimate the disparity data at time T+1. Alternatively, detection of disparity data at time T+2 may be performed before estimation of disparity data at time T+1, and estimation of disparity data at time T+1 may be performed with use of the area data and the disparity data at time T+2.

Alternatively, estimation of disparity data at time T+1 may be performed with use of the area data and the disparity data at each of times T and T+2. For example, estimation of the disparity data of an area at time T+1 may be performed with use of the area data and the disparity data at time T, and estimation of the disparity data of another area at time T+1 may be performed with use of the area data and the disparity data at time T+2. This makes it possible to estimate disparity data for each area using the area data and disparity data optimal for the area.

(4) According to the present embodiment, when the disparity estimation unit 115 estimates disparity, the distance information generation unit 132 extracts, from the disparity data D, disparities corresponding to each of the areas in the area data G, fills each of the areas with an intermediate value of the disparities corresponding to the area, and thereby generates distance information. However, no limitation is intended thereby, and the distance information generation unit 132 may fill each of the areas with an average value of the disparities corresponding to the area, instead of the intermediate value of the disparities corresponding to the area. Alternatively, the distance information generation unit 132 may extract, from the disparity data D, disparities corresponding to each of the areas of the area data G, fill each of the areas with the values of the extracted disparities as they are, and thereby generate distance information. This makes it possible to maintain the accuracy of the disparity data D at a high level when the accuracy of the disparity detection unit 121 is high.

Alternatively, even when the disparity detection unit 121 detects disparities, the distance information generation unit 132 may fill each of the areas of the area data G with an intermediate value of the disparities corresponding to the area. This equalizes the accuracy of disparity values regardless of whether the disparities are estimated or detected.

<Conclusion>

As described above, according to the present embodiment, two images (i.e., a main image and a sub-image) for stereoscopic viewing are captured, and the distance information used for disparity adjustment for stereoscopic viewing is generated during the capturing of the two images. In order to generate the distance information, area information indicating an object area, a background area, etc., is extracted from the main image. Then, disparities are calculated intermittently from main images and sub-images to generate disparity data. For area information not associated with disparity data, distance information is generated for interpolation by allocating corresponding disparity to each area of the area information. For example, the disparity may be estimated for each area of the area information based on the past disparity data stored in the disparity storage unit, and allocated to the area of the area information.

As described above, disparity data is generated intermittently, and missing disparity data is estimated for interpolation. This reduces the amount of processing and reduces power consumption.

Furthermore, while the distance information is estimated for interpolation, the area information corresponding to the distance information is always calculated. This prevents a mismatch in boundary between an image and the distance information, thus allowing for generation of a natural stereoscopic image.

According to the present embodiment, area information is always calculated and stored in the area storage unit, when disparity data is generated intermittently and missing disparity data is estimated for interpolation. This allows for comparison between pieces of area information in a time direction, and for determination of the correspondence between areas based on a result of the comparison.

According to the present embodiment, during the processing of determining the correspondence between areas by comparing pieces of area information, if two or more areas in a main image are determined as candidates for an area corresponding to a given area in another main image, the area having the largest overlap area with the given area is determined to be the corresponding area. In this way, the correspondence between areas can be determined by simply calculating the size of an overlap area. As a result, the amount of computation is reduced as compared to a case where a search is conducted on a per-pixel basis or on a per-area basis.

### Embodiment 2

An imaging device according to the present embodiment is characterized in that during estimation of disparity data, a comparison is made between color information corresponding to a target area for which disparity is to be estimated and color information corresponding to areas of another main image within a predetermined range with respect to the target area, and that the correspondence between areas is estimated based on a similarity in color information.

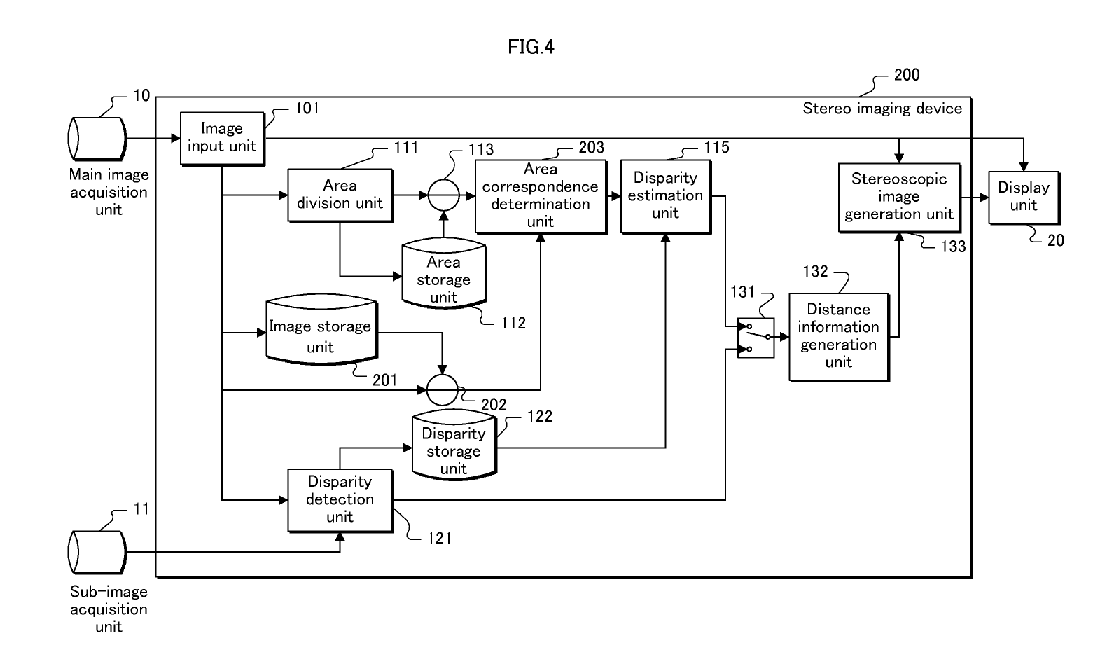

As shown in FIG. 4, a stereo imaging device 200 captures images of a subject so as to be stereoscopically viewable, generates distance data based on data on the captured images, adjusts disparity between the images or modifies the viewpoint of one of the images based on the distance data and the image data, and thereby displays a stereoscopic image.

<Structure>

FIG. 4 is a block diagram showing an imaging device according to Embodiment 2 of the present invention. In FIG. 4, the same components as those shown in FIG. 1 are provided with the same reference signs, and descriptions thereof are omitted.

The stereo imaging device 200 has the same structure as the stereo imaging device 100 except that the stereo imaging device 200 further includes an image storage unit 201 and an image comparison unit 202, and includes an area correspondence determination unit 203 instead of the area correspondence determination unit 114.

The image storage unit 201 is a recording medium for storing main image data output from the image input unit 101. The image storage unit 201 is realized by a hard disk, SSD, a semiconductor memory, or the like, for example.

The image comparison unit 202 compares color information corresponding to the main image data output from the image input unit 101 to color information corresponding to other image data stored in the image storage unit 201. Note that the color information refers to a brightness value of each pixel, color information of each pixel, or a combination a brightness value and color information of each pixel. Specifically, the image comparison unit 202 performs subtraction processing on the main image data output from the main image input unit 101 and the other main image data stored in the image storage unit 201, and generates image comparison data that is differential data between the main image data and the other main image data.

With reference to the area comparison data output from the area comparison unit 113 and the image comparison data output from the image comparison unit 202, the area correspondence determination unit 203 determines the correspondence between the areas of the main image output from the area division unit 111 and the areas of a main image generated at a different time and stored in the area storage unit 112, and generates area determination data which is a result of the determination. Specifically, the area correspondence determination unit 203 calculates a difference in brightness value, pixel value in color information, etc., between an area of the main image output from the area division unit 111 and areas of the main image that are generated at the different time and stored in the area storage unit 112 and that are within a predetermined range with respect to the area of the main image output from the area division unit 111, and determines the area of the main image at the different time which has the smallest difference in brightness or color information as a corresponding area that corresponds to the area of the main image output from the area division unit 111.

<Operations>

The following describes operations of the stereo imaging device 200 according to the present embodiment, with reference to the drawings.

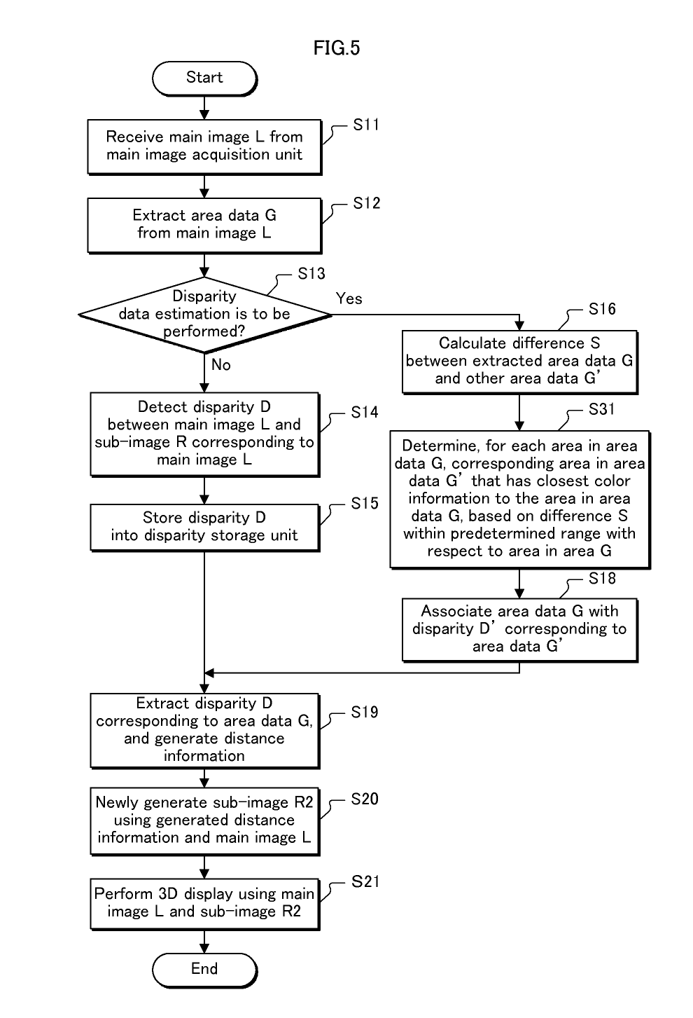

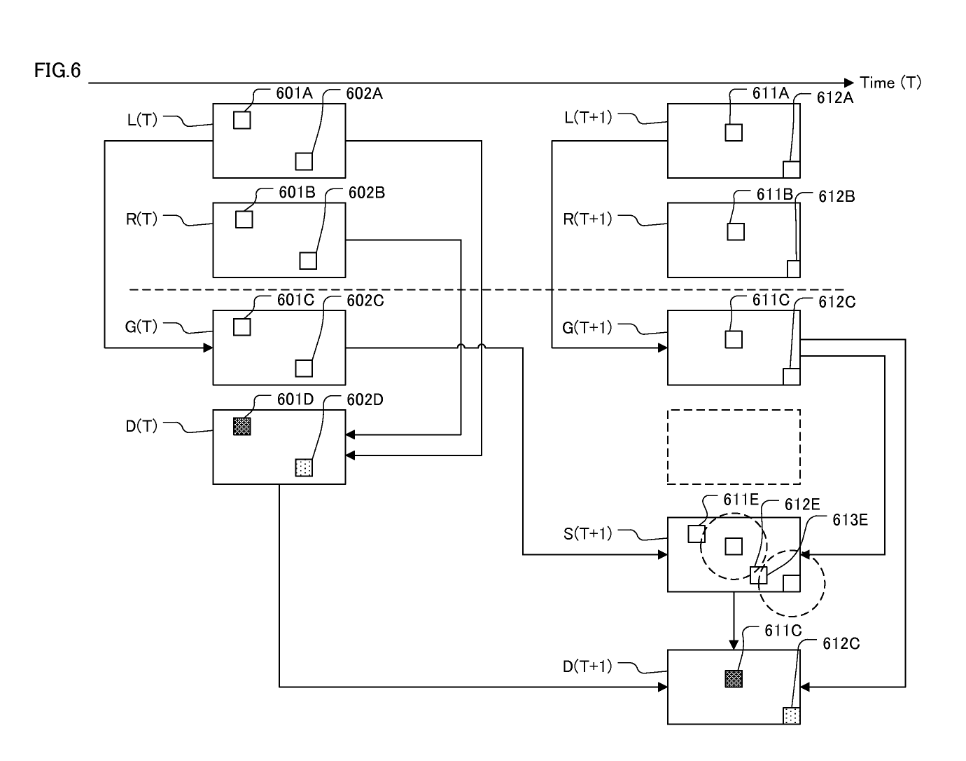

FIG. 5 is a flowchart showing operations on a main image, which are performed by the stereo imaging device 200 according to the present embodiment. In FIG. 5, the same steps as those shown in FIG. 2 are provided with the same step numbers, and descriptions thereof are omitted. FIG. 6 is a schematic diagram showing a main image, a sub-image, and distance information according to the present embodiment.

First, the stereo imaging device 200 sets parameters for viewpoint conversion, disparity adjustment, etc. The parameters are, for example, a focal distance, a distance between viewpoints after conversion, etc.

Operations at time T are the same as the operations by the stereo imaging device 100 in Embodiment 1, and descriptions thereof are therefore omitted.

Operations at time T+1 are the same as the operations by the stereo imaging device 100 according to Embodiment 1, except that step S31 is performed instead of step S17. Accordingly, descriptions are provided only on step S31 which is the difference from the operations in Embodiment 1.

Based on area comparison data S (T+1), the area correspondence determination unit 203 compares (i) the color information of an image L (T+1) corresponding to each area of area data G (T+1) to (ii) the color information of an image L (T) corresponding to each area of area data G (T), and generates area determination data (step S31). Specifically, an area 601C and an area 602C, which are within a predetermined range with respect to an area 611C, are determined as candidates as an area corresponding to the area 611C. Then, a color 611E of the area 601C and a color 612E of the area 602C are each compared to a color 611A of the area 611C. In the present example, the difference between the color 611E and the color 611A is smaller than the difference between the color 612E and the color 611A. Accordingly, the area 601C is associated with the area 611C. Similarly, the area 602C, which is within a predetermined range with respect to an area 612C, is determined as the area corresponding to the area 612C.

<Supplementary Remarks>

(1) According to the present embodiment, the area correspondence determination unit 203 determines the correspondence between areas with use of a difference in brightness value, pixel value in color information, etc. However, no limitation is intended thereby, and the correspondence between areas may be determined with use of a difference in average value or intermediate value (median) of brightness values or pixel values of color information within each of the areas.

Alternatively, the correspondence between areas may be determined by extracting, from each of the areas, either the center point or centroid point of the area or another feature point of the area, and by using the brightness value or the pixel value in the color information corresponding to the extracted point as a feature value. This reduces the amount of computation when the size of an area is large.

(2) According to the present embodiment, the area correspondence determination unit 203 determines the correspondence between areas with use of a difference in brightness value, pixel value in color information, etc. However, no limitation is intended thereby, and the correspondence between areas may be determined with use of an overlap area, the size of an area, etc., which are described in Embodiment 1 and the supplementary remarks (1) in Embodiment 1, in addition to the use of a difference in brightness value, pixel value in color information, etc. In this case, when there is more than one candidate for a corresponding area with respect to a given area as a result of determination using an overlap area, etc., the corresponding area with respect to the given area can be determined with use of a difference in brightness value or pixel value in color information.

Furthermore, a degree of priority may be established for each of a difference in brightness value and a difference in pixel value. Then, if there are two candidates for a corresponding area with respect to a given area, i.e., (i) an area having the smallest difference in brightness value from the given area and (ii) an area having the smallest difference in pixel value from the given area, the latter may be determined as the corresponding area according to the degrees of priority. Alternatively, the color information of a photo-object of interest may be stored in advance, and a high degree of priority may be established for a differential value indicating a difference from the color information stored in advance.

(3) The present embodiment may be combined with any of the supplementary remarks (2) to (4) in Embodiment 1.

<Conclusion>

As described above, according to the present embodiment, images are always input and area information of each of the images is always calculated when disparity data is generated intermittently and missing disparity data is estimated for interpolation, and these input images and the calculated area information are stored in the image storage unit and the area storage unit, respectively. This allows for comparison between images and comparison between pieces of area information in a time direction. As a result, even if there is no overlap area between a main image targeted for disparity estimation and another main image used for the disparity estimation, the correspondence between the areas of these main images can still be determined with use of color information.

### Embodiment 3

An imaging device according to the present embodiment is characterized by the function of, during estimation of disparity data, comparing the sizes of areas while performing enlargement processing (or reduction processing) of the areas.

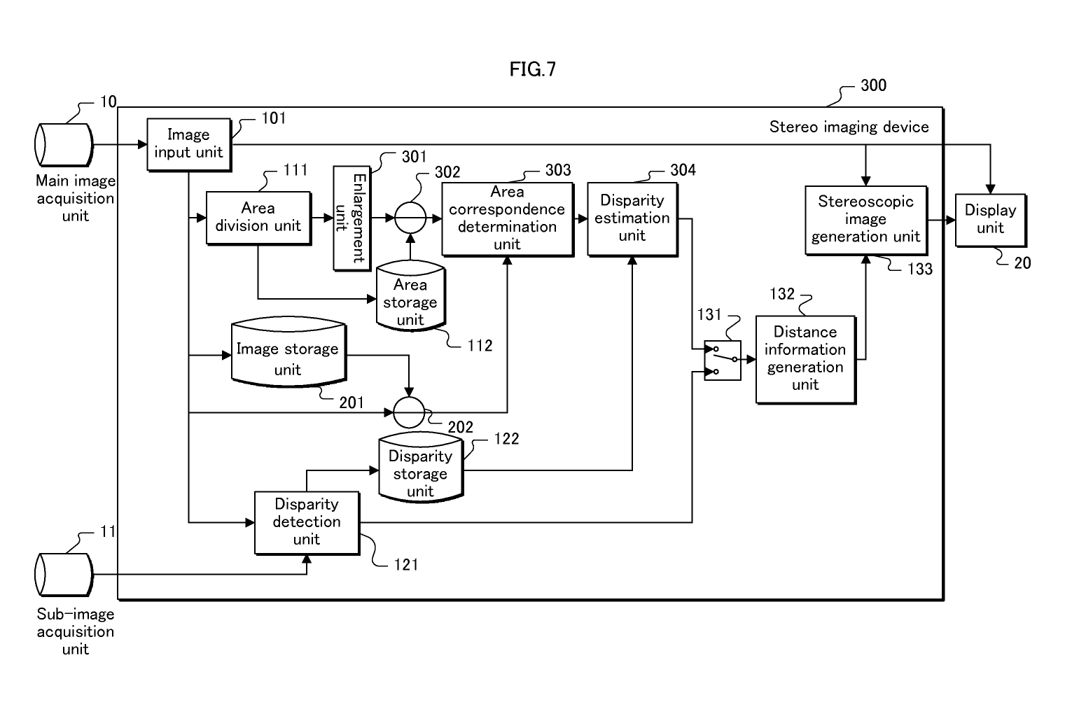

As shown in FIG. 7, a stereo imaging device 300 captures images of a subject so as to be stereoscopically viewable, generates distance data based on data on the captured images, adjusts disparity between the images or modifies the viewpoint of one of the images based on the distance data and the image data, and thereby displays a stereoscopic image.

<Structure>

FIG. 7 is a block diagram showing a stereo imaging device 300 according to Embodiment 3 of the present invention. In FIG. 7, the same components as those shown in FIGS. 1 and 4 are provided with the same reference signs, and descriptions thereof are omitted.

The stereo imaging device 300 has the same structure as the stereo imaging device 200 except that the stereo imaging device 300 further includes an enlargement unit 301 and also includes an area comparison unit 302 instead of the area comparison unit 113, an area correspondence determination unit 303 instead of the area correspondence determination unit 203, and a disparity estimation unit 304 instead of the disparity estimation unit 115.

The enlargement unit 301 either enlarges or reduces the areas of a main image output from the area division unit 111 at an arbitrary scaling factor, and outputs the enlarged or reduced areas to the area comparison unit 302. Also, the enlargement unit 301 outputs the scaling factor for enlargement or reduction to the disparity estimation unit 304.

The area comparison unit 302 compares the enlarged or reduced areas of the main image output from the enlargement unit 301 to the areas of a main image generated at a different time and stored in the area storage unit 112. Specifically, subtraction processing is performed on the enlarged or reduced areas of the main image output from the enlargement unit 301 and the areas of the main image generated at the different time and stored in the area storage unit 112. Based on the subtraction processing, area comparison data, which is differential data for each area of the main image, is created.

With reference to the area comparison data output from the area comparison unit 302 and the image comparison data output from the image comparison unit 202, the area correspondence determination unit 303 generates area determination data that determines the correspondence between the enlarged or reduced areas of the main image output from the enlargement unit 301 and the areas of the main image generated at the different time and stored in the area storage unit 112. Specifically, the area correspondence determination unit 303 calculates a difference in size of overlap area, brightness value, pixel value in color information, etc., between each of the enlarged or reduced areas of the main image output from the enlargement unit 301 and the areas of the main image generated at the different time and stored in the area storage unit 112, and determines the area of the main image at the different time which has the smallest difference as a corresponding area that corresponds to the enlarged or reduced area output from the enlargement unit 301.

The disparity estimation unit 304 determines the correspondence between the areas of the main image output from the area division unit 111 and the areas of the main image generated at the different time and stored in the area storage unit 112, based on the area determination data output from the area correspondence determination unit 303. Then, for each of the areas output from the area division unit 111, the disparity estimation unit 304 acquires, from the disparity storage unit 122, disparity data of an area that is of the main image generated at the different time and stored in the area storage unit 112, and that corresponds to the area output from the area division unit 111, and outputs the disparity data as disparity estimation data. At this time, the disparity estimation unit 304 acquires, from the enlargement unit 301, the scaling factor of the area output from the area division unit 111, and uses the scaling factor to correct the disparity data that is to be associated with the area.

<Operations>

The following describes operations of the stereo imaging device 300 according to the present embodiment, with reference to the drawings.

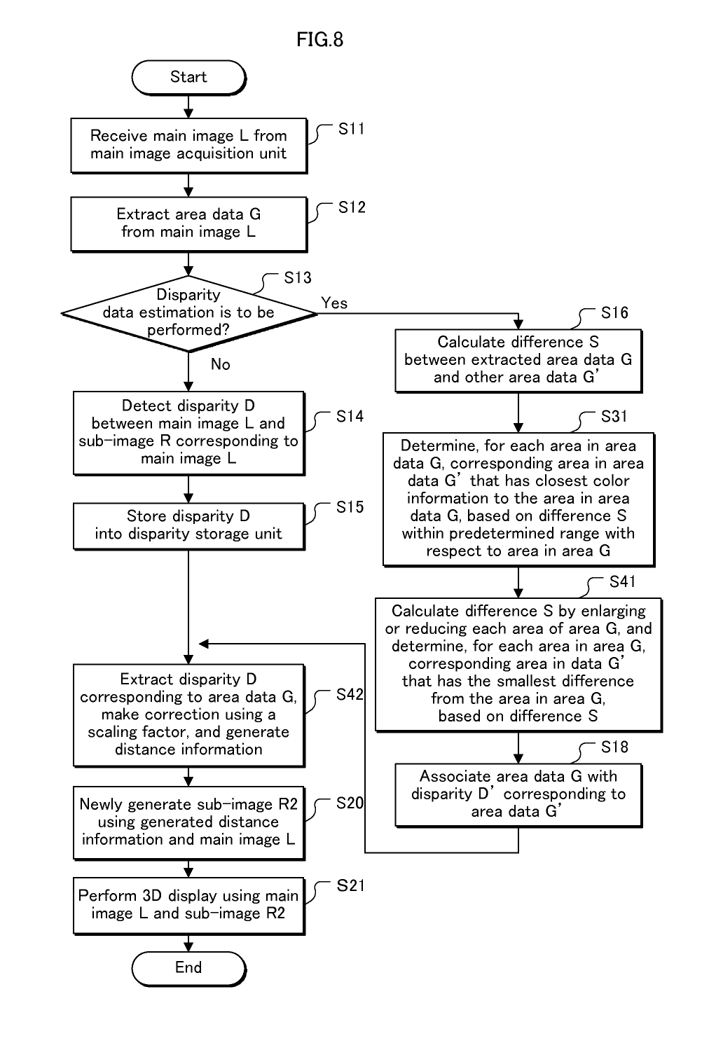

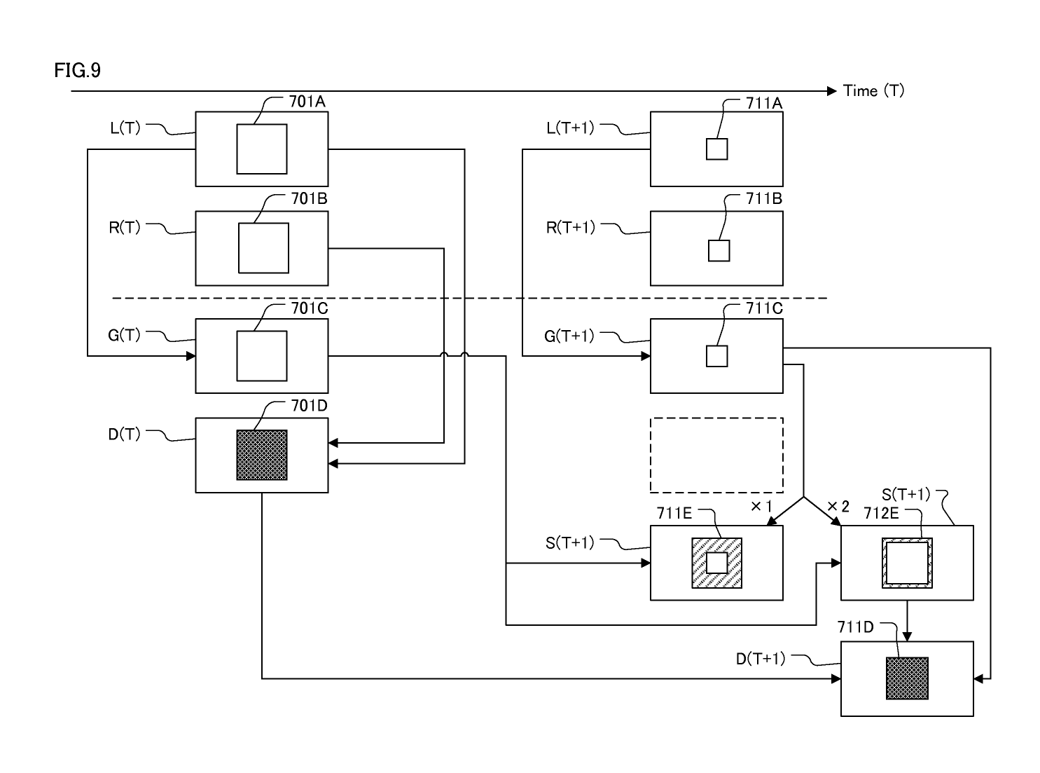

FIG. 8 is a flowchart showing operations on a main image, which are performed by the stereo imaging device 300 according to the present embodiment. In FIG. 8, the same steps as those shown in FIGS. 2 and 5 are provided with the same step numbers, and descriptions thereof are omitted. FIG. 9 is a schematic diagram showing a main image, a sub-image, and distance information according to the present embodiment.

First, the stereo imaging device 300 sets parameters for viewpoint conversion, disparity adjustment, etc. The parameters are, for example, a focal distance, a distance between viewpoints after conversion, etc.

Operations at time T are the same as the operations by the stereo imaging devices 100 and 200 in Embodiments 1 and 2, and descriptions thereof are therefore omitted.

Operations at time T+1 are the same as the operations by the stereo imaging device 200 according to Embodiment 2, except that steps S41 and S42 are performed instead of step S18. In the following, descriptions are provided of steps S31, S41, and S42.

Based on area comparison data S (T+1), the area correspondence determination unit 303 compares (i) the color information of an image L (T+1) corresponding to each area of area data G (T+1) to (ii) the color information of an image L (T) corresponding to each area of area data G (T) (step S31). Specifically, an area 701C, which is within a predetermined range with respect to an area 711C, is determined as the area corresponding to the area 711C.

Furthermore, the area correspondence determination unit 303 either enlarges or reduces the areas of area data G (T+1), and determines the correspondence between the areas of the area data G (T+1) and the areas of the area data G (T) with use of an overlap area therebetween (step S41). Specifically, the area 701C and the area 711C are determined to be in correspondence based on a non-overlap area 711E. Also, the area 701C and the area 711C enlarged at a scaling factor of two are determined to be in correspondence based on a non-overlap area 712E. Then, the area correspondence determination unit 303 compares the size of the non-overlap area 711E to the size of the non-overlap area 712E, and associates the area 701C with the area 711C enlarged at a scaling factor of two which corresponds to the area 712E, since the non-overlap area 712E is smaller than the non-overlap area 711E (i.e., the non-overlap area 712E indicates a smaller difference than the non-overlap area 711E).

After the areas of the area data G (T+1) are associated with the areas of the area data G (T), the disparity estimation unit 304 associates the areas of the area data G (T+1) with disparities of the disparity data D (T) corresponding to the areas of the area data G (T), and thereby generates disparity data D (T+1) (step S42). Specifically, the area 701D is read from the disparity data D (T) of the area 701C corresponding to the area 711C, and the disparity of the area 701D is corrected with use of a scaling factor of two, and the corrected disparity is associated with the area 711C. Note that the area 711D in FIG. 9 has the same size as the area 711C enlarged at a scaling factor of two. This is to show that the area 711C enlarged at a scaling factor of two is determined to correspond to the area 701D, and the disparity of the area 701D is corrected and associated with the area 711C. The area 711D in the disparity data D (T+1) is the same as each of a subject 711A in the main image L (T+1) and the area 711C in the area data G (T+1) in terms of position and the size.

<Supplementary Remarks>

(1) According to the present embodiment, the enlargement unit 301 enlarges or reduces the areas output from the area division unit 111, and outputs the enlarged or reduced areas to the area comparison unit 302. However, no limitation is intended thereby. The enlargement unit 301 may enlarge or reduce the areas stored in the area storage unit 112, and may output the enlarged or reduced areas to the area comparison unit 302. The area comparison unit 302 may compare the areas output from the area division unit 111 to the enlarged or reduced areas stored in the area storage unit 112.

(2) According to the present embodiment, the enlargement unit 301 enlarges the areas output from the area division unit 111 at a scaling factor of one or two, and outputs the enlarged areas to the area comparison unit 302. However, the value of the scaling factor is not limited to such. For example, the enlargement unit 301 may enlarge (or reduce) the areas at a scaling factor of 1, 1.22, or 0.82, and may output the enlarged (or reduced) areas to the area comparison unit 302. Alternatively, for example, the enlargement unit 301 may enlarge the areas at a scaling factor of 1.22 and further enlarge the areas at a scaling factor of 1.22, or may perform six repetitions of enlargement processing at a scaling factor of 1.22 and perform six repetitions of reduction processing at a scaling factor of 0.82. In this way, the area correspondence determination unit 303 can find a combination of areas having the smallest difference therebetween, and can also find the scaling factor used for the combination.

(3) According to the present embodiment, there is only one candidate for the area corresponding to the area 711C. However, in a case there is more than one candidate for the corresponding area, a degree of priority may be established for each of a difference in size of overlap area (or a difference mentioned in the supplementary remarks (1) in Embodiment 1, such as a similarity in shape of area) and a difference in color information (or a difference mentioned in the supplementary remarks (1) in Embodiment 2, such as a difference in brightness value), and the corresponding area may be determined according to the degrees of priority. For example, a degree of priority may be set high for a difference in color information. In this way, in a case where there are two candidates for the area corresponding to a given area, i.e., (i) an area having the largest overlap area with respect to the given area but having a large difference in color information from the given area and (ii) an area having the second largest overlap area with respect to the given area but having a small difference in color information from the given area, the area having the second largest overlap area but having a small difference in color information can be determined as the corresponding area.

(4) According to the present embodiment, when associating disparity data with an area, the disparity estimation unit 304 corrects the disparity data using a scaling factor corresponding to the area. However, no limitation is intended thereby. Instead of the disparity estimation unit 304 correcting the disparity data, the distance information generation unit 132 may correct distance information during generation of the distance information.

(5) The present embodiment may be combined with any of the supplementary remarks (1) to (4) in Embodiment 1 and the supplementary remarks (1) and (2) in Embodiment 2.

<Conclusion>

As described above, according to the present embodiment, when disparity data is generated intermittently and missing disparity data is estimated for interpolation, disparity estimation data is generated by comprehensively evaluating area information and color information.

Also, according to the present embodiment, when disparity data is generated intermittently and missing disparity data is estimated for interpolation, area information is always calculated for each image. During comparison of these pieces of area information in a time direction, each area of the area information is subjected to enlargement processing (or reduction processing). In this way, for example, provided that the correspondence between an area in a preceding main image and an area in a succeeding main image are determined by enlarging the area in the succeeding image, it can be determined that the photo-object of the area in the succeeding main image is farther away from the imaging device than the photo-object of the area in the preceding main image. Accordingly, estimated disparity data can be corrected with use of the scaling factor used to enlarge the area in the succeeding image. This makes it possible to estimate disparity data even for a photo-object that has moved closer to or further away from the imaging device.

### Embodiment 4

An imaging device according to the present embodiment is characterized by the function of acquiring single-viewpoint images, intermittently acquiring distance information for some of the single-viewpoint images, and interpolating distance information for the other single-viewpoint images to generate stereoscopic images.

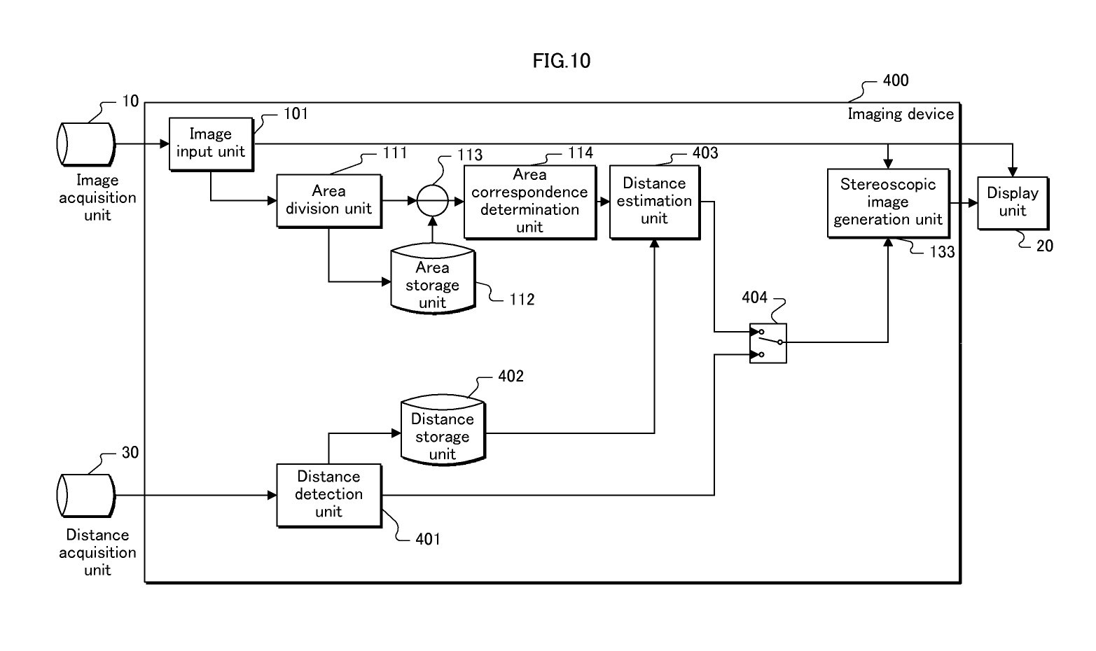

An imaging device 400 shown in FIG. 10 captures images of a subject from a single viewpoint, intermittently acquires distance information for some of the captured images, and displays a stereoscopic image composed of a main image and a sub-image, where the main image is a captured image and the sub-image is an image generated from distance information and the captured image.

<Structure>

FIG. 10 is a block diagram showing an imaging device 400 according to Embodiment 4 of the present invention. In FIG. 10, the same components as those shown in FIG. 1 are provided with the same reference signs, and descriptions thereof are omitted. In the following descriptions, the main images are simply referred to as images, but there is no difference between the main images in Embodiments 1 to 3 and the images in the present embodiment. The images output by the image acquisition unit 10 of the imaging device 400 are either the first images or the second images.

The imaging device 400 has the same structure as the stereo imaging device 100 except that the imaging device 400 does not include the distance information generation unit 132, and includes: a distance detection unit 401 connected to a distance acquisition unit 30, instead of the disparity detection unit 121 connected to the sub-image acquisition unit 11; a distance storage unit 402 instead of the disparity storage unit 122; a distance estimation unit 403 instead of the disparity estimation unit 115; and a distance selection unit 404 instead of the disparity selection unit 131.

The distance acquisition unit 30 acquires information used to acquire the distance between the image acquisition unit 10 and a subject photographed by the image acquisition unit 10. The distance acquisition unit 30 detects the distance by transmitting an ultrasonic wave, a millimeter wave, etc., to the subject, and measuring the time that elapses before a reflected wave from the subject reaches the distance acquisition unit 30, the phase difference between the waves, etc. The distance acquisition unit 30 intermittently acquires distance information while the image acquisition unit 10 generates and outputs images; specifically, the intermittent timings are each a timing at which the distance selection unit 404 makes a selection such that the distance detection unit 401 is to generate the distance information. In the present embodiment, the image acquisition unit 10 outputs 30 images per second, and the intermittent timings are set to once every two frames. The distance acquisition unit 30 acquires distance information once every two outputs while 30 images are output per second. In other words, the distance acquisition unit 30 acquires distance information 15 times per second.

The distance detection unit 401 receives an input of distance information from the distance acquisition unit 30.

The distance storage unit 402 is a recording medium for storing distance information output from the distance detection unit 401, and is realized by a hard disk drive, an SSD, a semiconductor memory, or the like, for example.

The distance estimation unit 403 acquires area determination data from the area correspondence determination unit 114 and, for each of the areas output from the area division unit 111, acquires, from the distance storage unit 402, distance information of a corresponding area of a main image generated at a different time and stored in the area storage unit 112, and outputs the distance information as distance estimation data.

The distance selection unit 404 selects whether the distance detection unit 401 is to generate distance information to be output to the stereoscopic image generation unit 133. When the selection is made such that the distance detection unit 401 is to generate the distance information, the distance selection unit 404 outputs the distance information detected by the distance detection unit 401 to the stereoscopic image generation unit 133. When the selection is made such that the distance detection unit 401 is not to generate the distance information, the distance selection unit 404 outputs the distance estimation data output by the distance estimation unit 403 to the stereoscopic image generation unit 133. Specifically, the distance selection unit 404 makes a selection such that the distance detection unit 401 is to generate distance information at intermittent timings, and that the distance estimation unit 403 is to estimate distance information at other timings. Note that the distance detection unit 401 stops operations while not generating distance information, and that the area correspondence determination unit 114 and the distance estimation unit 403 stop operations while the distance detection unit 401 generates distance information.

<Operations>

The following describes operations of the imaging device 400 according to the present embodiment.

First, the imaging device 400 sets parameters for generation of a stereoscopic image. The parameters are, for example, a focal distance, a distance between viewpoints, etc.

Operations at time T are the same as the operations by the stereo imaging device 100 according to Embodiment 1, except the following differences.

In the operations of the imaging device 400, the image input unit 101 acquires an image L (T) from the image acquisition unit 10, instead of performing step S11.

Operations of step S12 are the same as those in Embodiment 1, and descriptions thereof are thus omitted.

Next, the distance selection unit 404 selects whether distance information estimation is to be performed, instead of performing step S13. Here, the distance selection unit 404 makes a selection such that the distance detection unit 401 is to detect distance information.

Next, the distance detection unit 401 receives, from the distance acquisition unit 30, an input of distance information pertaining to a subject, instead of performing step S14.

Next, the distance detection unit 401 stores the distance information into the distance storage unit 402, instead of performing step S15.

Descriptions on operations from step S19 onwards are omitted since the operations are the same as those in Embodiment 1, except that step S19 is omitted, and that the stereoscopic image generation unit 133 acquires the distance information from the distance selection unit 404.

The following describes operations of the imaging device 400 at time T+1.

In the operations of the imaging device 400, the image input unit 101 acquires an image L (T+1) from the image acquisition unit 10, instead of performing step S11.

Operations of step S12 are the same as those in Embodiment 1, and descriptions thereof are thus omitted.

Next, the distance selection unit 404 selects whether distance information estimation is to be performed, instead of performing step S13. Here, the distance selection unit 404 makes a selection such that the distance estimation unit 403 is to estimate distance information.

Descriptions on operations from step S16 onwards are omitted since the operations are the same as those in Embodiment 1, except that the distance estimation unit 403 generates the distance information corresponding to the image L (T+1) by associating the areas of area data G (T+1) with the distance information corresponding to the areas of area data G (T) in step S18, that step S19 is omitted, and that the stereoscopic image generation unit 133 acquires the distance information from the distance selection unit 404 in step S20.

Note that distance information is estimated once every two frames. Accordingly, at time T+2, the imaging device 400 repeats the same operations performed at time T. Also, at time T+3, the imaging device 400 repeats the same operations performed at time T+1.

<Conclusion>

As described above, according to the present embodiment, a stereoscopic image can be generated by intermittently generating distance information corresponding to a single-viewpoint image and by estimating missing distance information for interpolation. This eliminates the need for the distance acquisition unit to operate at the same speed as the image acquisition unit, thus reducing the power consumption of the distance acquisition unit.

<Modification>

An imaging device according to the present modification is characterized in that an image acquisition unit acquires single-viewpoint images, uses two different focal distances, and generates distance information using two images each having a different focal distance.

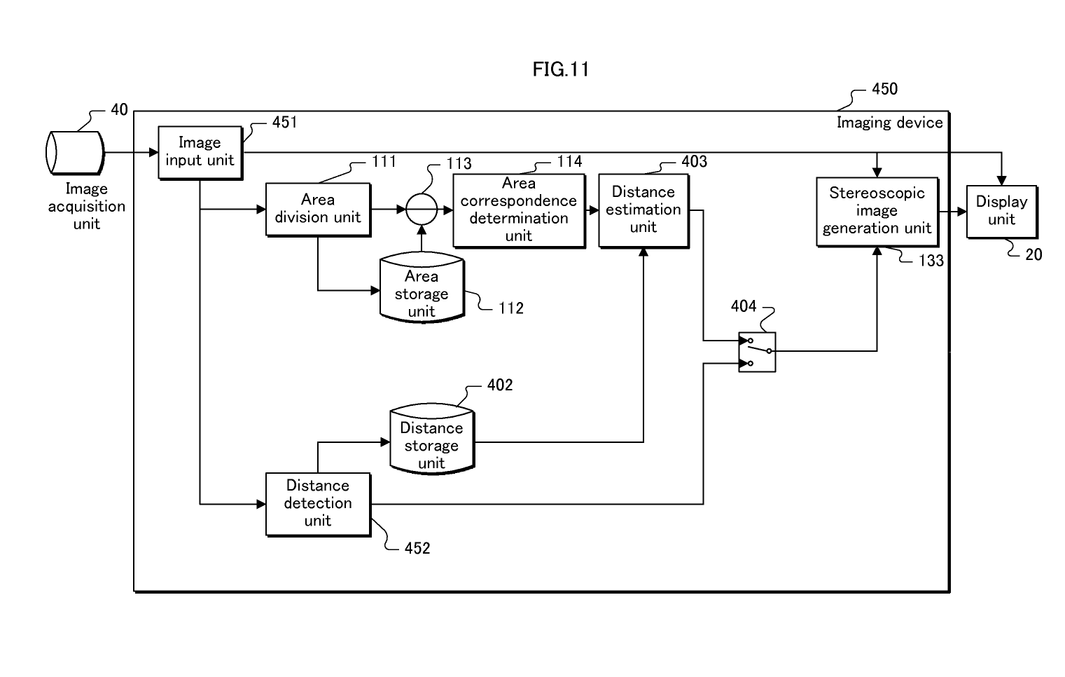

An imaging device 450 shown in FIG. 11 captures images of a subject from a single viewpoint with use of two different focal distances, acquires distance information with use of two images each having a different focal distance, and displays a stereoscopic image composed of a main image and a sub-image, where the main image is a captured image and the sub-image is an image generated from distance information and the captured image.

<Structure>

FIG. 11 is a block diagram showing an imaging device 450 according to the present modification. In FIG. 11, the same components as those shown in FIGS. 1 and 10 are provided with the same reference signs, and descriptions thereof are omitted.

The imaging device 450 has the same structure as the imaging device 400, except that the imaging device 450 includes: an image input unit 451 connected to an image acquisition unit 40, instead of the image input unit 101 connected to the image acquisition unit 10; and a distance detection unit 452 connected to the image input unit 451, instead of the distance detection unit 401 connected to the distance acquisition unit 30.

The image acquisition unit 40 captures images of a subject by alternately switching between two different focal distances, and outputs a video signal obtained by the capturing of the images to the imaging device 450.

The image input unit 451 receives inputs of images from the image acquisition unit 40, handles an image captured with use of one of the focal distances as a main image, and handles an image captured with use of the other focal distance as a sub-image.

The distance detection unit 452 detects the distance between the subject and the image acquisition unit 40, with use of the main image and the sub-image that correspond to consecutive photographing times. Specifically, the distance detection unit 452 searches for corresponding points between the main image and the sub-image, and employs the principle of triangulation with use of two focal distances which are photography conditions of the main image and the sub-image (see Japanese Patent Application Publication No. 2004-239791, for example), and thereby detects the distance between the subject and the image acquisition unit 40. Note that the distance detection unit 452 may calculate a pseudo distance instead of detecting the distance, and may output the pseudo distance as distance information.

<Operations>

Operations of the imaging device 450 are the same as those of the imaging device 400 according to Embodiment 4, and descriptions thereof are thus omitted.

<Conclusion>

As described above, according to the present modification, a stereoscopic image can be generated with use of only the imaging device and the image acquisition unit having a function of changing a focal distance. This eliminates the need to detect a distance for every main image, and thus reducing the amount of computation by the imaging device 450.

<Supplementary Remarks>

(1) According to Embodiment 4 and the modification, the imaging device 400 or 450 determines the correspondence between areas with use of an overlap area, similarly to Embodiment 1. However, no limitation is intended thereby, and the correspondence between areas may be determined with use of a similarity in shape or the like, similarly to the supplementary remarks (1) of Embodiment 1.

Also, the imaging device 400 or 450 may include the image storage unit 201, the image comparison unit 202, and the area correspondence determination unit 203, and may determine the correspondence between areas in the same manner as in Embodiment 2. Similarly, the imaging device 400 or 450 may include the enlargement unit 301 and the area correspondence determination unit 303, and may determine the correspondence between areas in the same manner as in Embodiment 3. In this case, it is of course possible to apply the supplementary remarks in Embodiment 2 or 3.

(2) According to Embodiment 4 and the modification, the distance estimation unit 403 generates distance information by associating the areas of the area data G (T+1) with the distance information of the corresponding areas of the area data G (T), and outputs the distance information thus generated. However, no limitation is intended thereby. When associating the areas of the area data G (T+1) with the distance information of the corresponding areas of the area data G (T), the distance estimation unit 403 may generate distance information by filling each of the areas of the area data G (T+1) with an intermediate value or average value of the distance information of the corresponding area of the area data G (T), similarly to the supplementary remarks (4) of Embodiment 1, and may output the distance information thus generated.

(3) According to the modification, the image acquisition unit 40 captures images of a subject by alternately switching between two different focal distances. However, the image acquisition unit 40 may capture images of a subject by intermittently switching between two different focal distances. For example, the image acquisition unit 40 may capture an image of a subject with a focal distance corresponding to a sub-image once every three frames, and may capture an image of the subject with a focal distance corresponding to a main image twice every three frames. This reduces the frequency of the image acquisition unit 40 switching between the focal distances, and also reduces the frequency of the distance detection unit 452 performing operations, thus further reducing power consumption.

### Embodiment 5

The present embodiment describes a system including an imaging device according to the present invention.

<Structure>

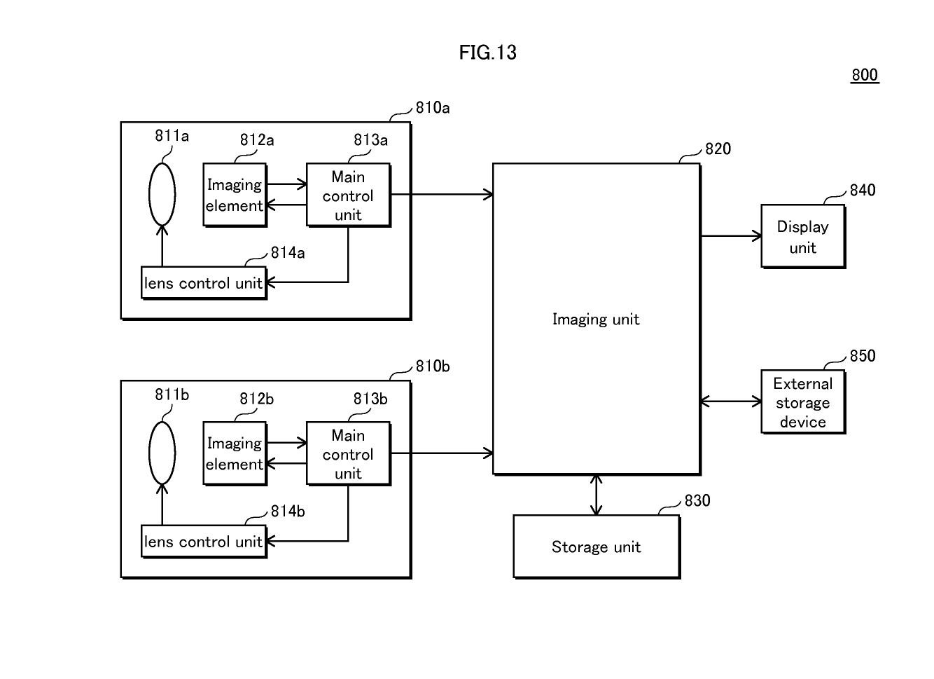

FIG. 13 is a block diagram showing an imaging system 800 according to the present embodiment. The imaging system 800 includes a camera 810a, a camera 810b, an imaging unit 820, a storage unit 830, a display unit 840, and an external storage device 850.

The camera 810a is the same as the main image acquisition unit 10 according to Embodiment 1. The camera 810a includes a lens 811a, an imaging element 812a, a main control unit 813a, and a lens control unit 814a. The imaging element 812a is a CCD (Charge Coupled Device), for example. The imaging element 812a acquires an optical signal via the lens 811a, converts the optical signal into an electrical signal, and outputs the electrical signal to the main control unit 813a. The lens control unit 814a adjusts the focus of the lens 811a, etc., under the control of the main control unit 813a. The main control unit 813a is an IC (Integrated Circuit), for example. The main control unit 813a acquires an electrical signal output from the imaging element 812a, and outputs the electrical signal to the imaging unit 820 as a video signal. Furthermore, the main control unit 813a controls the imaging element 812a and the lens control unit 813a to adjust the shutter speed, gain, focus, etc.

A camera 810b is the same as the sub-image acquisition unit 11 according to Embodiment 1. The camera 810b includes a lens 811b, an imaging element 812b, a main control unit 813b, and a lens control unit 814b, which have the same functions as the lens 811a, the imaging element 812a, the main control unit 813a, and the lens control unit 814a, respectively.

The main control unit 813a and the main control unit 813b operate in coordination with each other so that the focus, shutter speed, etc., of the camera 810a coincides with the focus, shutter speed, etc., of the camera 810b.

The imaging unit 820 is the same as the imaging device 100 according to Embodiment 1, except that the imaging unit 820 does not include the area storage unit 112 nor the disparity storage unit 122.

The storage unit 830 is the same as a combination of the area storage unit 112 and the disparity storage unit 122 in the imaging device 100 according to Embodiment 1.

The display unit 840 is the same as the display unit 20 according to Embodiment 1. The display unit 840 acquires a stereo image signal from the imaging unit 820, and displays a main image and a sub-image indicated by the stereo image signal. Note that the display unit 840 may acquire a main image and a sub-image from the camera 810a and the camera 810b, respectively, and may display the main image and the sub-image thus acquired.

An external storage device 850 is configured so that a recording medium is attachable thereto. Examples of the recording medium include a CD (Compact Disc), an MO (Magneto Optical Disk), a DVD (Digital Versatile Disc), a BD (Blu-ray Disc), or a semiconductor memory. The external storage device 850 acquires the main image and the sub-image from the imaging unit 820, and writes these images into the recording medium attached thereto.

<Operations>

Descriptions on operations by the imaging system 800 are omitted since the operations are the same as the operations in Embodiment 1, except that a stereoscopic image which is generated by the imaging unit 820 and is composed of a main image and a sub-image is output to the display unit 840 and is also stored in the external storage device 850.

<Supplementary Remarks>

(1) According to the present embodiment, the imaging unit 820 is the same as the imaging device 100, except that the imaging unit 820 does not include the area storage unit 112 nor the disparity storage unit 122. Also, the storage unit 830 is the same as a combination of the area storage unit 112 and the disparity storage unit 122. However, no limitation is intended thereby. For example, the imaging unit 820 may be the same as the imaging device 200 according to Embodiment 2, except that the imaging unit 820 does not include the area storage unit 112, the disparity storage unit 122, nor the image storage unit 201. Also, the storage unit 830 may be the same as a combination of the area storage unit 112, the disparity storage unit 122, and the image storage unit 201. Alternatively, the imaging unit 820 may be the same as the imaging device 300 according to Embodiment 3, except that the imaging unit 820 does not include the area storage unit 112, the disparity storage unit 122, nor the image storage unit 201. Also, the storage unit 830 may be the same as a combination of the area storage unit 112, the disparity storage unit 122, and the image storage unit 201.

Alternatively, the imaging unit 820 may be the same as the imaging device 400 according to Embodiment 4 except that the imaging unit 820 does not include the area storage unit 112 nor the disparity storage unit 122. Also, the storage unit 830 may be the same as a combination of the area storage unit 112 and the disparity storage unit 122, and a distance sensor may be used instead of the camera 810b. Alternatively, the imaging unit 820 may be the same as the imaging device 450, except that the imaging unit 820 does not include the area storage unit 112 nor the disparity storage unit 122. Also, the storage unit 830 may be the same as a combination of the area storage unit 112 and the disparity storage unit 122, and a camera which can change a focal distance may be used instead of the camera 810a and the camera 810b.

### Other Modifications of Embodiments

(1) According to Embodiments 1 to 5 and the modifications thereof, the distance information indicates the distance from the viewpoint to each of the photo-objects in an image in units of pixels, and is used in combination with the image for generation of a two-viewpoint stereoscopic image. However, the present invention is not limited to such. For example, instead of the distance information, it is possible to use disparity information indicating the disparity between images showing the same subject but differing in terms of viewpoint, or alternatively, to use a virtual distance which is assumed to be a focal distance or inter-viewpoint distance (i.e., distance between viewpoints) differing from the distance defined in the original photography conditions. Yet alternatively, the distance information may not necessarily indicate the distance between the viewpoint and each of the photo-objects, and may indirectly indicate the distance, such as the distance between each of the photo-objects and a focal position or a virtual distance.

Yet alternatively, the distance information may be prepared for each of the photo-objects if the distance information within the area of each of the photo-objects indicates approximately the same value.

(2) According to Embodiments 1 to 3, the main image acquisition unit 10 and the sub-image acquisition unit 11 are positioned with a distance of 6.5 cm from each other. However, the present invention is not limited to this. For example, the distance between the main image acquisition unit 10 and the sub-image acquisition unit 11 may be an arbitrary distance, such as 3 cm. In this case, natural stereoscopic viewing cannot be realized with a combination of a main image and a sub-image that have been acquired; however, a stereoscopic image generated by the stereoscopic image generation unit 133 is suitable for stereoscopic viewing. This makes it possible to freely arrange the main image acquisition unit 10 and the sub-image acquisition unit 11. Also, the main image acquisition unit 10 and the sub-image acquisition unit 11 may be combined with either the imaging device 100, 200, or 300 to form a single apparatus, so that the size of the apparatus can be reduced.

(3) According to Embodiments 1 to 5, the area division unit 111 divides a main image into areas with use of the graph cut algorithm while each of the subjects in the main image is regarded as one area (segment). However, the present invention is not limited to this. For example, the area division unit 111 may divide a main image through filtering processing, such as edge enhancement for extraction of outlines.

(4) According to Embodiments 1 to 3 and the modification of Embodiment 4, the disparity detection unit 121 or the distance detection unit 452 detects a disparity or a distance with the block matching method using the SAD. However, the present invention is not limited to this. For example, in the block matching method, the sum of squared difference (SSD) in brightness or zero-mean normalized cross-correction (ZNCC) may be used. Also, if the pixel values are expressed in an RGB space, then only G values or the weighted average of R, G, and B values may be used instead of the difference in brightness, for example.

Alternatively, the disparity detection unit 121 or the distance detection unit 452 may, for example, use a graph cut method instead of the block matching method.

(5) According to Embodiments 1 to 4 and the modifications thereof, the stereoscopic image generation unit 133 generates a stereoscopic image and outputs the stereoscopic image to the display unit 20. However, the present invention is not limited to this. For example, the stereoscopic image generation unit 133 may store the generated stereoscopic image onto a recording medium or output the generated stereoscopic image to another image processing device via a network or the like.

Alternatively, the imaging device 100, 200, 300, 400, or 450 may not include the stereoscopic image generation unit 133, and may store a combination of a main image and distant information corresponding to the main image onto a recording medium or output the combination to another image processing device via a network or the like. This allows the other image processing device to perform image processing, such as encoding processing or blur processing, with use of the image having the distance information generated by the imaging device according to the present invention. The distance information in the above case is not limited to indicating the distance between a subject and the image acquisition unit, and may be disparity information, virtual distance information, or the like.

(6) According to Embodiments 1 to 5 and the modifications thereof, main images, sub-images, and images are moving images. However, the present invention is not limited to this. For example, the (main) image acquisition unit 10 or the camera 810a may output two or more still images. In this case, for example, the imaging device 100 may use one still image as the first image and perform the same operations as the operations at time T according to Embodiment 1, and may use a next still image as the second image and perform the same operations as the operations at time T+1 according to Embodiment 1, so as to generate as many stereoscopic still images as the number of input main images.

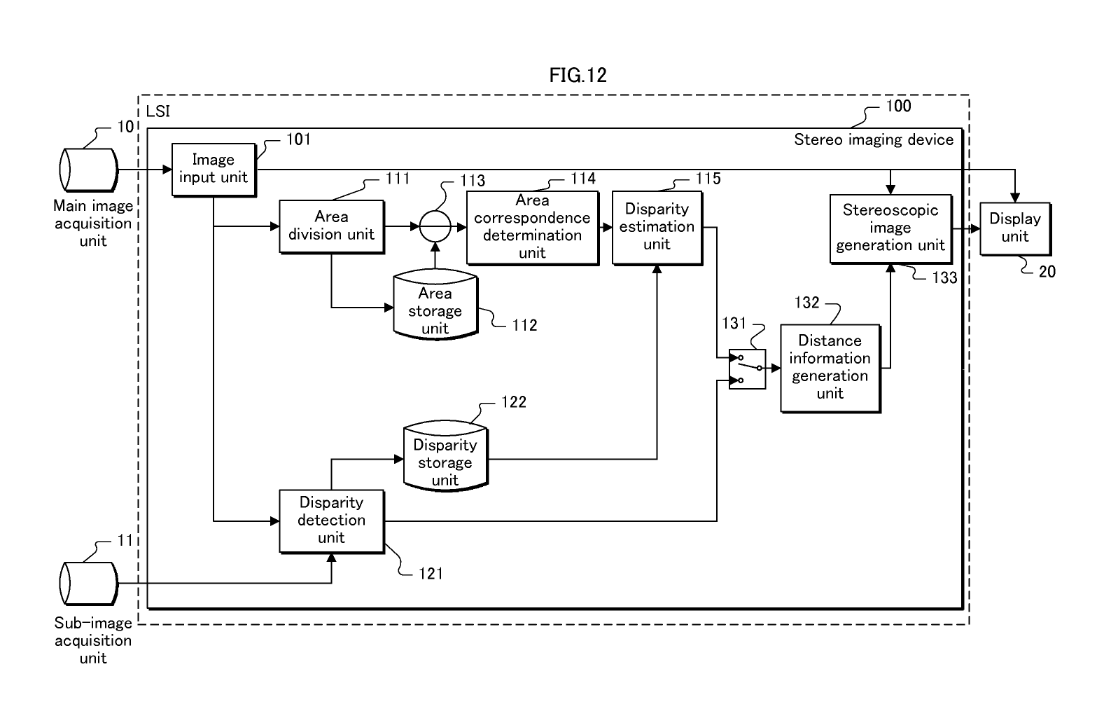

(7) The imaging device according to any of Embodiments 1 to 4 and the modifications thereof or the imaging unit according to Embodiment 5 may be typically implemented as an LSI (Large Scale Integration), which is an integrated circuit. Each circuit may be a single chip. Alternatively, all or a subset of the circuits may be integrated into a single chip. For example, the area storage unit 112 and the disparity storage unit 122 may be integrated into the same integrated circuit together with other circuits as shown in FIG. 12, or may be separately integrated into individual integrated circuits.

Although the LSI is mentioned above, the name IC (Integrated Circuit), system LSI, super LSI, or ultra LSI may be applied according to the degree of integration.

In addition, the method for assembling integrated circuits is not limited to the LSI, and a dedicated circuit or a general-purpose processor may be used. It is possible to use an FPGA (Field Programmable Gate Array) which is programmable after the LSI is manufactured, or a reconfigurable processor which allows for reconfiguration of the connection and setting of internal circuit cells.

Furthermore, if technology for forming integrated circuits that replaces LSIs emerges, owing to advances in semiconductor technology or to another derivative technology, the integration of functional blocks may naturally be accomplished using such technology.

Also, the imaging device according to any of Embodiments 1 to 4 and the modifications thereof or the imaging unit according to Embodiment 5 may be implemented as a combination of a program written onto a recording medium and a computer reading and executing the program. The recording medium may be a memory card, a CD-ROM, or any other recording medium. Furthermore, the imaging device according to any of Embodiments 1 to 4 and the modifications thereof or the imaging unit according to Embodiment 5 may be implemented as a combination of a program downloaded via a network and a computer downloading and executing the program via the network. This program is for performing imaging processing that comprises: receiving inputs of a first image and a second image that are captured at different times from the same viewpoint; dividing each of the first image and the second image to extract areas corresponding one-to-one to objects; generating distance information for each area of the first image by detecting a distance from the viewpoint to the object corresponding to the area of the first image; selecting whether distance information is to be generated for each area of the second image by detecting a distance from the viewpoint to the object corresponding to the area of the second image; when the selection is made negatively, determining a correspondence between the areas of the first image and the areas of the second image; and based on a result of the determination of the correspondence, generating distance information for the second image by associating each of the areas of the second image with the distance information, of one of the areas of the first image, that is estimated to indicate the distance from the viewpoint to the object corresponding to the area of the second image.

(8) Descriptions on the above embodiments and modifications are merely examples of the present invention, and various improvements and modifications can be made without exceeding the scope of the present invention.

The following describes the structures and effects of an imaging device, an integrated circuit thereof, an imaging method, an imaging program, and an imaging system according to embodiments.

(a) An imaging device according to an embodiment comprises: an image input unit configured to receive inputs of a first image and a second image that are captured at different times from the same viewpoint; an area division unit configured to divide each of the first image and the second image to extract areas corresponding one-to-one to objects; a distance detection unit configured to generate distance information for each area of the first image by detecting a distance from the viewpoint to the object corresponding to the area of the first image; a distance selection unit configured to select whether the distance detection unit is to generate distance information for each area of the second image by detecting a distance from the viewpoint to the object corresponding to the area of the second image; an area correspondence determination unit configured to, when the distance selection unit selects negatively, determine a correspondence between the areas of the first image and the areas of the second image; and a distance estimation unit configured to, based on a result of the determination by the area correspondence determination unit, generate distance information for the second image by associating each of the areas of the second image with the distance information, of one of the areas of the first image, that is estimated to indicate the distance from the viewpoint to the object corresponding to the area of the second image.

Also, an integrated circuit according to an embodiment comprises: an image input unit configured to receive inputs of a first image and a second image that are captured at different times from the same viewpoint; an area division unit configured to divide each of the first image and the second image to extract areas corresponding one-to-one to objects; a distance detection unit configured to generate distance information for each area of the first image by detecting a distance from the viewpoint to the object corresponding to the area of the first image; a distance selection unit configured to select whether the distance detection unit is to generate distance information for each area of the second image by detecting a distance from the viewpoint to the object corresponding to the area of the second image; an area correspondence determination unit configured to, when the distance selection unit selects negatively, determine a correspondence between the areas of the first image and the areas of the second image; and a distance estimation unit configured to, based on a result of the determination by the area correspondence determination unit, generate distance information for the second image by associating each of the areas of the second image with the distance information, of one of the areas of the first image, that is estimated to indicate the distance from the viewpoint to the object corresponding to the area of the second image.

Also, an imaging method according to an embodiment comprises: receiving inputs of a first image and a second image that are captured at different times from the same viewpoint; dividing each of the first image and the second image to extract areas corresponding one-to-one to objects; generating distance information for each area of the first image by detecting a distance from the viewpoint to the object corresponding to the area of the first image; selecting whether distance information is to be generated for each area of the second image by detecting a distance from the viewpoint to the object corresponding to the area of the second image; when the selection is made negatively, determining a correspondence between the areas of the first image and the areas of the second image; and based on a result of the determination of the correspondence, generating distance information for the second image by associating each of the areas of the second image with the distance information, of one of the areas of the first image, that is estimated to indicate the distance from the viewpoint to the object corresponding to the area of the second image.

Also, an imaging program according to an embodiment is a program for performing imaging processing in which distance information is generated for images, the imaging processing comprising: receiving inputs of a first image and a second image that are captured at different times from the same viewpoint; dividing each of the first image and the second image to extract areas corresponding one-to-one to objects; generating distance information for each area of the first image by detecting a distance from the viewpoint to the object corresponding to the area of the first image; selecting whether distance information is to be generated for each area of the second image by detecting a distance from the viewpoint to the object corresponding to the area of the second image; when the selection is made negatively, determining a correspondence between the areas of the first image and the areas of the second image; and based on a result of the determination of the correspondence, generating distance information for the second image by associating each of the areas of the second image with the distance information, of one of the areas of the first image, that is estimated to indicate the distance from the viewpoint to the object corresponding to the area of the second image.

Also, a recording medium according to an embodiment is a computer readable recording medium storing thereon a program for performing imaging processing in which distance information is generated for images, the imaging processing comprising: receiving inputs of a first image and a second image that are captured at different times from the same viewpoint; dividing each of the first image and the second image to extract areas corresponding one-to-one to objects; generating distance information for each area of the first image by detecting a distance from the viewpoint to the object corresponding to the area of the first image; selecting whether distance information is to be generated for each area of the second image by detecting a distance from the viewpoint to the object corresponding to the area of the second image; when the selection is made negatively, determining a correspondence between the areas of the first image and the areas of the second image; and based on a result of the determination of the correspondence, generating distance information for the second image by associating each of the areas of the second image with the distance information, of one of the areas of the first image, that is estimated to indicate the distance from the viewpoint to the object corresponding to the area of the second image.

Also, an imaging system according to an embodiment is an imaging system comprising: a camera configured to capture a first image and a second image at different times from the same viewpoint; an imaging device configured to receive the first image and the second image from the camera; and a recording medium for storing images each having distance information generated by the imaging device, wherein the imaging device including: an image input unit configured to receive inputs of the first image and the second image; an area division unit configured to divide each of the first image and the second image to extract areas corresponding one-to-one to objects; a distance detection unit configured to generate distance information for each area of the first image by detecting a distance from the viewpoint to the object corresponding to the area of the first image; a distance selection unit configured to select whether the distance detection unit is to generate distance information for each area of the second image by detecting a distance from the viewpoint to the object corresponding to the area of the second image; an area correspondence determination unit configured to, when the distance selection unit selects negatively, determine a correspondence between the areas of the first image and the areas of the second image; and a distance estimation unit configured to, based on a result of the determination by the area correspondence determination unit, generate distance information for the second image by associating each of the areas of the second image with the distance information, of one of the areas of the first image, that is estimated to indicate the distance from the viewpoint to the object corresponding to the area of the second image.

According to the structures described above, when the distance estimation unit estimates distance information for the second image, the distance detection unit does not generate distance information for the second image. This means that the distance detection unit does not need to perform processing for generating distance information for the second image. Also, when estimating distance information for the second image, the distance estimation unit allocates the distance information of each area of the first image to the corresponding area of the second image. This makes it possible to generate distance information for the second image without causing a mismatch in the outline of each area between the second image and the distance information.

(b) The imaging device of section (a) above may further comprise an area comparison unit configured to compare area information of each of the areas of the second image to area information of each of the areas of the first image and generate area comparison information, wherein the area correspondence determination unit may determine the correspondence between the areas of the first image and the areas of the second image, based on the area comparison information.

According to the above structure, comparison is performed between the area information of each of the areas of the first image and the area information of each of the areas of the second image. This makes it possible to determine the correspondence between the areas of the first image and the areas of the second image.

(c) The imaging device of section (a) above may further comprise an image comparison unit configured to compare color information of the second image to color information of the first image and generate image comparison information, wherein the area correspondence determination unit may determine the correspondence between the areas of the first image and the areas of the second image, based on the image comparison information.

According to the above structure, comparison is performed between the color information of the entirety of the first image and the color information of the entirety of the second image. This makes it possible to determine the correspondence between the areas of the first image and the areas of the second image.

(d) The imaging device of section (a) above may further comprise: an image comparison unit configured to compare color information of the second image to color information of the first image and generate image comparison information; and an area comparison unit configured to compare area information of each of the areas of the second image to area information of each of the areas of the first image and generate area comparison information, wherein the area correspondence determination unit may determine the correspondence between the areas of the first image and the areas of the second image, based on the image comparison information and the area comparison information.

According to the above structure, comparison between the first image and the second image involves: the comparison between the area information of each of the areas of the first image and the area information of each of the areas of the second image; and the comparison between the color information of the entirety of the first image and the color information of the entirety of the second image. This makes it possible to determine the correspondence between the areas of the first image and the areas of the second image with higher accuracy.

(e) In the imaging device of either section (b) or (d) above, the area comparison unit may perform the comparison after scaling either the areas of the first image or the areas of the second image, and the distance estimation unit may correct, for each of the areas subjected to the scaling, the distance information corresponding to the area by using a scaling factor used for the scaling.

The above structure has the following advantage. Suppose that the areas of the first image differ in size from the areas of the second image at the time of the comparison between the area information of each of the areas of the first image and the area information of each of the areas of the second image. In this case, if there is a combination of an area of the first image and an area of the second image that can be determined to be in correspondence after the sizes of the respective areas are closely matched, then the correspondence between these areas can be determined by scaling either the area of the first image or the area of the second image. In addition, this structure allows for correction in distance using the scaling factor used to scale one of the area of the first image and the area of the second image. As a result, the distance to the object corresponding to the area of the second image can be appropriately estimated even if the object corresponding to the area of the first image differs in size from the object corresponding to the area of the second image due to the object approaching or moving away from the viewpoint.

(f) In the imaging device of any of sections (b), (d), and (e) above, the area comparison information may include at least one of a size of an overlap area between each of the areas of the first image and each of the areas of the second image, a similarity in shape therebetween, or a distance between a centroid position of each of the areas of the first image and a centroid position of each of the areas of the second image.

According to the above structure, when comparison is performed between the area information of each of the areas of the first image and the area information of each of the areas of the second image, the correspondence between the areas of the first image and the areas of the second image can be determined with use of the properties relating to the shapes of the respective areas, the positions of the respective areas, etc.

(g) In the imaging device of any of sections (c), (d), and (e) above, the image comparison information may include at least one of a similarity in brightness between the first image and the second image or a similarity in color information therebetween.

According to the above structure, when comparison is performed between the color information of the entirety of the first image and the color information of the entirety of the second image, the correspondence between the areas of the first image and the areas of the second image can be determined with use of the properties relating to brightness or color.

(h) In the imaging device of section (a) above, the image input unit may be further configured to receive an input of a sub-image that has a disparity with respect to the first image, and the distance detection unit may generate the distance information of the first image by using the first image and the sub-image.

In this way, the imaging device can generate the distance information of the first image with use of the sub-image.

(j) In the imaging device of section (h) above, the sub-image may differ in focal distance from the first image, and may be generated as a result of a lens or a camera sensor moving back and forth.

In this way, the imaging device can generate the sub-image by using a camera with two or more focal distances, and can generate the distance information of the first image by triangulation.

(k) In the imaging device of section (h) above, the image input unit may be further configured to receive images from at least two cameras, and to handle images from one of the cameras as the first image and the second image and handle an image from another one of the cameras as the sub-image, and the distance detection unit may detect the disparity between the first image and the sub-image, and may generate the distance information of the first image based on the detected disparity.

In this way, the imaging device can generate a stereoscopic image from the images captured from at least two different viewpoints, while images from one of the viewpoints are handled as the first image and the second image, and an image from another viewpoint is handled as the sub-image.

### INDUSTRIAL APPLICABILITY

The present invention relates to an imaging device that generates an image signal for stereoscopic viewing. In particular, the present invention is effective in reducing the amount of computation and reducing power consumption during generation of distance information.

Accordingly, the present invention is useful for image recording devices, such as digital video cameras and digital still cameras. In addition, the present invention is useful for image transmission devices, image editing devices, etc.

### REFERENCE SIGNS LIST

Imaging device 100, 200, 300, 400, 450
Image input unit 101, 451
Area division unit 111
Area storage unit 112
Area comparison unit 113, 302
Area correspondence determination unit 114, 203, 303
Disparity estimation unit 115, 304
Disparity detection unit 121
Disparity storage unit 122
Disparity selection unit 131
Distance information generation unit 132
Stereoscopic image generation unit 133
Image storage unit 201
Image comparison unit 202
Enlargement unit 301
Distance detection unit 401, 452
Distance storage unit 402
Distance estimation unit 403
Distance selection unit 404

1-15. (canceled)

16. An imaging device comprising:
an image input unit configured to receive inputs of a first image and a second image that are captured at different times from the same viewpoint;
an area division unit configured to divide each of the first image and the second image to extract areas corresponding one-to-one to objects;
a distance detection unit configured to generate distance information for each area of the first image by detecting a distance from the viewpoint to the object corresponding to the area of the first image;
a distance selection unit configured to select whether the distance detection unit is to generate distance information for each area of the second image by detecting a distance from the viewpoint to the object corresponding to the area of the second image;
an area correspondence determination unit configured to, when the distance selection unit selects negatively, determine a correspondence between the areas of the first image and the areas of the second image; and
a distance estimation unit configured to, based on a result of the determination by the area correspondence determination unit, generate distance information for the second image by associating each of the areas of the second image with the distance information, of one of the areas of the first image, that is estimated to indicate the distance from the viewpoint to the object corresponding to the area of the second image.

17. The imaging device of claim 16 further comprising
an area comparison unit configured to compare area information of each of the areas of the second image to area information of each of the areas of the first image and generate area comparison information, wherein
the area correspondence determination unit determines the correspondence between the areas of the first image and the areas of the second image, based on the area comparison information.

18. The imaging device of claim 16 further comprising
an image comparison unit configured to compare color information of the second image to color information of the first image and generate image comparison information, wherein
the area correspondence determination unit determines the correspondence between the areas of the first image and the areas of the second image, based on the image comparison information.

19. The imaging device of claim 16 further comprising:
an image comparison unit configured to compare color information of the second image to color information of the first image and generate image comparison information; and
an area comparison unit configured to compare area information of each of the areas of the second image to area information of each of the areas of the first image and generate area comparison information, wherein
the area correspondence determination unit determines the correspondence between the areas of the first image and the areas of the second image, based on the image comparison information and the area comparison information.

20. The imaging device of claim 17, wherein
the area comparison unit performs the comparison after scaling either the areas of the first image or the areas of the second image, and
the distance estimation unit corrects, for each of the areas subjected to the scaling, the distance information corresponding to the area by using a scaling factor used for the scaling.

21. The imaging device of claim 17, wherein
the area comparison information includes at least one of a size of an overlap area between each of the areas of the first image and each of the areas of the second image, a similarity in shape therebetween, or a distance between a centroid position of each of the areas of the first image and a centroid position of each of the areas of the second image.

22. The imaging device of claim 18, wherein
the image comparison information includes at least one of a similarity in brightness between the first image and the second image or a similarity in color information therebetween.

23. The imaging device of claim 16, wherein
the image input unit is further configured to receive an input of a sub-image that has a disparity with respect to the first image, and
the distance detection unit generates the distance information of the first image by using the first image and the sub-image.

24. The imaging device of claim 23, wherein
the sub-image differs in focal distance from the first image, and is generated as a result of a lens or a camera sensor moving back and forth.

25. The imaging device of claim 23, wherein
the image input unit is further configured to receive images from at least two cameras, and to handle images from one of the cameras as the first image and the second image and handle an image from another one of the cameras as the sub-image, and
the distance detection unit detects the disparity between the first image and the sub-image, and generates the distance information of the first image based on the detected disparity.

26. An integrated circuit comprising:
an image input unit configured to receive inputs of a first image and a second image that are captured at different times from the same viewpoint;
an area division unit configured to divide each of the first image and the second image to extract areas corresponding one-to-one to objects;
a distance detection unit configured to generate distance information for each area of the first image by detecting a distance from the viewpoint to the object corresponding to the area of the first image;
a distance selection unit configured to select whether the distance detection unit is to generate distance information for each area of the second image by detecting a distance from the viewpoint to the object corresponding to the area of the second image;
an area correspondence determination unit configured to, when the distance selection unit selects negatively, determine a correspondence between the areas of the first image and the areas of the second image; and
a distance estimation unit configured to, based on a result of the determination by the area correspondence determination unit, generate distance information for the second image by associating each of the areas of the second image with the distance information, of one of the areas of the first image, that is estimated to indicate the distance from the viewpoint to the object corresponding to the area of the second image.

27. An imaging method comprising:
receiving inputs of a first image and a second image that are captured at different times from the same viewpoint;
dividing each of the first image and the second image to extract areas corresponding one-to-one to objects;
generating distance information for each area of the first image by detecting a distance from the viewpoint to the object corresponding to the area of the first image;
selecting whether distance information is to be generated for each area of the second image by detecting a distance from the viewpoint to the object corresponding to the area of the second image;
when the selection is made negatively, determining a correspondence between the areas of the first image and the areas of the second image; and
based on a result of the determination of the correspondence, generating distance information for the second image by associating each of the areas of the second image with the distance information, of one of the areas of the first image, that is estimated to indicate the distance from the viewpoint to the object corresponding to the area of the second image.

28. A non-transitory computer readable recording medium storing thereon a program for causing a computer to perform imaging processing in which distance information is generated for images, the imaging processing comprising:
receiving inputs of a first image and a second image that are captured at different times from the same viewpoint;
dividing each of the first image and the second image to extract areas corresponding one-to-one to objects;
generating distance information for each area of the first image by detecting a distance from the viewpoint to the object corresponding to the area of the first image;
selecting whether distance information is to be generated for each area of the second image by detecting a distance from the viewpoint to the object corresponding to the area of the second image;
when the selection is made negatively, determining a correspondence between the areas of the first image and the areas of the second image; and
based on a result of the determination of the correspondence, generating distance information for the second image by associating each of the areas of the second image with the distance information, of one of the areas of the first image, that is estimated to indicate the distance from the viewpoint to the object corresponding to the area of the second image.

29. An imaging system comprising:
a camera configured to capture a first image and a second image at different times from the same viewpoint;
an imaging device configured to receive the first image and the second image from the camera; and
a recording medium for storing images each having distance information generated by the imaging device, wherein
the imaging device including:
an image input unit configured to receive inputs of the first image and the second image;
an area division unit configured to divide each of the first image and the second image to extract areas corresponding one-to-one to objects;
a distance detection unit configured to generate distance information for each area of the first image by detecting a distance from the viewpoint to the object corresponding to the area of the first image;
a distance selection unit configured to select whether the distance detection unit is to generate distance information for each area of the second image by detecting a distance from the viewpoint to the object corresponding to the area of the second image;
an area correspondence determination unit configured to, when the distance selection unit selects negatively, determine a correspondence between the areas of the first image and the areas of the second image; and
a distance estimation unit configured to, based on a result of the determination by the area correspondence determination unit, generate distance information for the second image by associating each of the areas of the second image with the distance information, of one of the areas of the first image, that is estimated to indicate the distance from the viewpoint to the object corresponding to the area of the second image.

30. The imaging device of claim 16, wherein
the distance estimation unit generates the distance information for the second image by filling each of the areas of the second image with the distance information of one of the areas of the first image associated with the area of the second image.

31. The imaging device of claim 30, wherein
the distance estimation unit fills every pixel of each of the areas of the second image with a representative value of the distance information of one of the areas of the first image associated with the area of the second image, the representative value being used as a distance from the viewpoint to the object corresponding to the area of the second image.
